(19) United States
(12) Patent Application Publication
(10) Pub. No.: US 2020/0104030 A1
(43) Pub. Date: Apr. 2, 2020

(54) USER INTERFACE ELEMENTS FOR CONTENT SELECTION IN 360 VIDEO NARRATIVE PRESENTATIONS

(71) Applicant: PodOp, Inc., Santa Monica, CA (US)

(72) Inventors: Nicolas Dedual, New York, NY (US); Ulysses Popple, Brooklyn, NY (US); Steven Soderbergh, New York, NY (US); Edward James Solomon, New York, NY (US)

(21) Appl. No.: 16/590,867

(22) Filed: Oct. 2, 2019

Related U.S. Application Data
(60) Provisional application No. 62/740,161, filed on Oct. 2, 2018.

(51) Int. Cl. G06F 3/0481; H04N 13/183; G06T 15/20

(52) U.S. Cl. CPC G06F 3/04815; H04N 13/183; G06F 3/0482; G06T 2200/24; G06T 15/205

(57) ABSTRACT

An interactive narrative presentation includes a plurality of narrative segments, with a variety of available media content consumer selectable paths or directions, typically specified by a director or editor. The content consumer can select a path or path segment at each of a number of points, e.g., decision points, in the narrative presentation via user interface elements or narrative prompts, providing the consumer the opportunity to follow a storyline they find interesting. Each consumer follows a “personalized” path through the narrative. The narrative prompts or user interface elements can include visually distinct portions of the narrative segments, for example outlines of actors or characters associated with respective visually distinct characteristics (e.g., colors). The narrative prompts may be overlaid or combined with a presentation of the underlying narrative (primary content). The visually distinct characteristic can map to respective actions.

### TECHNICAL FIELD

This application is generally related to interactive media narrative presentation in which media content consumers select paths through a narrative presentation that comprises a plurality of narrative segments in audio, visual, and audio-visual forms.

### BACKGROUND

The art of storytelling is a form of communication dating back to ancient times. Storytelling allows humans to pass information on to one another for entertainment and instructional purposes. Oral storytelling has a particularly long history and involves the describing of a series of events using words and other sounds. More recently, storytellers have taken advantage of pictures and other visual presentations to relate the events comprising the story. Particularly effective is a combination of audio and visual representations, most commonly found in motion pictures, television programs, and video presentations.

Until recently, narrative presentations have typically been non-interactive, the series of events forming the story being presented as a sequence of scenes in a predefined set or chosen by a director or editor. Although “Director's Cuts” and similar presentations may provide a media content consumer with additional media content (e.g., additional scenes, altered order of scenes) or information related to one or more production aspects of the narrative, such information is often presented as an alternative to the standard narrative presentation (e.g., theatrical release) or simultaneous (e.g., as a secondary audio program) with the standard narrative presentation. At times, such “Director's Cuts” provide the media content consumer with additional scenes (e.g., scenes removed or “cut” during the editing process to create a theatrical release). However, such presentation formats still rely on the presentation of scenes in an order completely defined by the director or editor before release.

At other times, supplemental content in the form of voiceovers or similar features involving actors or others involved in the production of the narrative is available to the media content consumer (e.g., BD-LIVE® for BLU-RAY® discs). However, such content is often provided as an alternative to or contemporaneous with the narrative. Thus, such features rely on the presentation of scenes in an order predefined by the director or editor.

Some forms of media provide the media content consumer with an ability to affect the plotline. For example, video games may implement a branching structure, where various branches will be followed based on input received from the media content consumer. Also for example, instructional computer programs may present a series of events where media content consumer input selections change the order of presentation of the events, and can cause the computer to present some events, while not presenting other events.

### SUMMARY

A variety of new user interface structures and techniques are set out herein, particularly suited for use in interactive narrative presentation. These techniques and structures address various technical problems in defining and/or delivering narratives in a way that allows media content to be customized for the media content consumers while the media content consumers explore the narratives in a way that is at least partially under the control of the media content consumer. These techniques and structures may also address various technical problems in other presentation environments or scenarios. In some instances, a media content player and/or backend system may implement the delivery of the narrative presentation employing some of the described techniques and structures. The described techniques and structures may also be used to provide an intuitive user interface that allows a content consumer to interact with an interactive media presentation, in a seamless form, for example where the user interface elements are rendered to appear as if they were part of the original filming or production.

A narrative may be considered a defined sequence of narrative events that conveys a story or message to a media content consumer. Narratives are fundamental to storytelling, games, and educational materials. A narrative may be broken into a number of distinct segments, which may, for example, comprise one or more of a number of distinct scenes. A narrative may even be presented episodically, with episodes being released periodically, aperiodically, or even in bulk (e.g., entire season of episodes all released on the same day).

Characters within the narrative will interact with other characters, other elements in the story, and the environment itself as the narrative presentation progresses. Even with the most accomplished storytelling, only a limited number of side storylines and only a limited quantity of character development can occur within the timeframe prescribed for the overall narrative presentation. Often editors and directors will selectively omit a significant portion of the total number of narrative threads or events available for inclusion in the narrative presentation. The omitted narrative threads or events may be associated with the perspective, motivation, mental state, or similar character aspects of one or more characters appearing in the narrative presentation. While omitted narrative threads or events do not necessarily change the overall storyline (i.e., outcome) of the narrative, they can provide the media content consumer with insights on the perspective, motivation, mental state, or similar other physical or mental aspects of one or more characters appearing in the narrative presentation, and hence modify the media content consumer's understanding or perception of the narrative and/or characters. Such omitted narrative threads or events may be in the form of distinct narrative segments, for instance vignettes or additional side storylines related to (e.g., sub-plots of) the main storyline of the larger narrative.

Providing a media content consumer with user selectable icons, the user selectable icons each corresponding to a respective narrative segment or portion of a path, at defined points (e.g., decision points) along a narrative provides an alternative to the traditional serial presentation of narrative segments selected solely by the production and/or editing team. Advantageously, the ability for media content consumers to view a narrative based on personally selected narrative segments or paths enables each media content consumer to uniquely experience the narrative.

Linear narratives, for instance films, movies, or other productions, are typically uniquely stylized. The style may be associated with a particular director, cinematographer, or even a team of people who work on the specific production. For example, some directors may carry a similar style through multiple productions, while other directors may change their style from production to production. At least part of the stylistic effect is related to or defined by the cameras used to film various scenes, and even the lighting used during filming. Stylistic effects associated with cameras can be represented at least to some extent by the characteristics of the cameras. Each camera or more precisely each camera and lens combination can be characterized by a set of intrinsic characteristics or parameters and a set of extrinsic characteristics or parameters.

The style is an important artistic aspect of most productions, and any changes to the style may detract from the enjoyment and artistic merit of the production. In is typically desirable to avoid modifying or otherwise detracting from the style of a given production.

Whether the production (e.g., narrative) is to be presented in an interactive format, user interface elements must be introduced to allow control over viewing. Some user interface elements can control play, pause, fast forward, fast rewind, scrubbing. Interactive narratives may additionally provide user interface elements that allow the viewer or content consumer to select a path through a narrative. Applicant has recognized that it is important to prevent the user interface from modifying or otherwise detracting from the style of a production.

Notably, a user interface or user interface element can detract from the style of a production if not adapted to be consistent with the style of the production. Given the large divergence in styles, such adaptation of the user interface typically would need to be one a one to one basis. Such an approach would be difficult, time consuming, and costly.

To be able to properly view and interact with 360 video, so that we may load additional content relative to our selections, we have solved the following problems: i) how to render the 360 videos onto a desired device so that there's no distortion and all viewing angles are accessible to the user or viewer; ii) how to visually represent parts of the video that are interactive; and iii) creation of a mode of interaction for 360 video via user or viewer selection.

### BRIEF DESCRIPTION OF THE DRAWINGS

In the drawings, identical reference numbers identify similar elements or acts. The sizes and relative states of elements in the drawings are not necessarily drawn to scale. For example, the positions of various elements and angles are not necessarily drawn to scale, and some of these elements are arbitrarily enlarged and positioned to improve drawing legibility. Further, the particular shapes of the elements as drawn are not necessarily intended to convey any information regarding the actual shape of the particular elements, and have been solely selected for ease of recognition in the drawings.

FIG. 1 is a schematic diagram of an illustrative content delivery system network that includes media content creators, media content editors, and media content consumers, according to at least one illustrated embodiment.

FIG. 2 is a flow diagram of a narrative presentation with a number of narrative prompts, points (e.g., segment decision points), and narrative segments, according to at least one illustrated implementation.

FIG. 3 is a simplified block diagram of an illustrative content editor system, according to at least one illustrated implementation.

FIG. 4 is a schematic diagram that illustrates a transformation or mapping of an image from a three-dimensional space or three-dimensional surface to a two-dimensional space or two-dimensional surface according to a conventional technique, solely to provide background understanding.

FIG. 5 is a schematic diagram that illustrates a transformation or mapping of an image a two-dimensional space to a three-dimensional space of an interior of a virtual spherical shell, the three dimensional space represented as two hemispheres of the virtual spherical shell to ease illustration, according to one illustrated implementation.

FIG. 6 is a schematic diagram that illustrates a virtual three-dimensional space in the form of a virtual spherical shell having an interior surface with a virtual camera at a defined posed relative to the interior surface of the virtual spherical shell, according to one illustrated implementation.

FIGS. 7A-7C are screen captures that illustrate sequential operations to generate user-selectable user interface elements and map the generated user interface elements to be displayed in registration with respective content in a narrative presentation.

FIG. 8 is a flow diagram of a method of operation of a system to present a narrative segment to a media content consumer, according to at least one illustrated implementation.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with processors, user interfaces, nontransitory storage media, media production, or media editing techniques have not been shown or described in detail to avoid unnecessarily obscuring descriptions of the embodiments. Additionally, tethered and wireless networking topologies, technologies, and communications protocols are not shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

As used herein the term “production” should be understood to refer to media content that includes any form of human perceptible communication including, without limitation, audio media presentations, visual media presentations, and audio/visual media presentations, for example a movie, film, video, animated short, television program.

As used herein the terms “narrative” and “narrative presentation” should be understood to refer to a human perceptible presentation including audio presentations, video presentations, and audio-visual presentations. A narrative typically presents a story or other information in a format including at least two narrative segments having a distinct temporal order within a time sequence of events of the respective narrative. For example, a narrative may include at least one defined beginning or foundational narrative segment. A narrative also includes one additional narrative segment that falls temporally after the beginning or foundational narrative segment. In some implementations, the one additional narrative segment may include at least one defined ending narrative segment. A narrative may be of any duration.

As used herein the term “narrative segment” should be understood to refer to a human perceptible presentation including an audio presentation, a video presentation, and an audio-visual presentation. A narrative includes a plurality of narrative events that have a sequential order within a timeframe of the narrative, extending from a beginning to an end of the narrative. The narrative may be composed of a plurality of narrative segments, for example a number of distinct scenes. At times, some or all of the narrative segments forming a narrative may be user selectable. At times some of the narrative segments forming a narrative may be fixed or selected by the narrative production or editing team. At times some of the narrative segments forming a narrative may be selected by a processor-enabled device based upon information and/or data related to the media content consumer. At times an availability of some of the narrative segments to a media content consumer may be conditional, for example subject to one or more conditions set by the narrative production or editing team. A narrative segment may have any duration, and each of the narrative segments forming a narrative may have the same or different durations. In most instances, a media content consumer will view a given narrative segment of a narrative in its entirety before another narrative segment of the narrative is subsequently presented to the media content consumer.

As used herein the terms “production team” and “production or editing teams” should be understood to refer to a team including one or more persons responsible for any aspect of producing, generating, sourcing, or originating media content that includes any form of human perceptible communication including, without limitation, audio media presentations, visual media presentations, and audio/visual media presentations.

As used herein the terms “editing team” and “production or editing teams” should be understood to refer to a team including one or more persons responsible for any aspect of editing, altering, joining, or compiling media content that includes any form of human perceptible communication including, without limitation, audio media presentations, visual media presentations, and audio/visual media presentations. In at least some instances, one or more persons may be included in both the production team and the editing team.

As used herein the term “media content consumer” should be understood to refer to one or more persons or individuals who consume or experience media content in whole or in part through the use of one or more of the human senses (i.e., seeing, hearing, touching, tasting, smelling).

As used herein the term “aspects of inner awareness” should be understood to refer to inner psychological and physiological processes and reflections on and awareness of inner mental and somatic life. Such awareness can include, but is not limited to the mental impressions of an individual's internal cognitive activities, emotional processes, or bodily sensations. Manifestations of various aspects of inner awareness may include, but are not limited to self-awareness or introspection. Generally, the aspects of inner awareness are intangible and often not directly externally visible but are instead inferred based upon a character's words, actions, and outwardly expressed emotions. Other terms related to aspects of inner awareness may include, but are not limited to, metacognition (the psychological process of thinking about thinking), emotional awareness (the psychological process of reflecting on emotion), and intuition (the psychological process of perceiving somatic sensations or other internal bodily signals that shape thinking). Understanding a character's aspects of inner awareness may provide enlightenment to a media content consumer on the underlying reasons why a character acted in a certain manner within a narrative presentation. Providing media content including aspects of a character's inner awareness enables production or editing teams to include additional material that expands the narrative presentation for media content consumers seeking a better understanding of the characters within the narrative presentation.

The headings and Abstract of the Disclosure provided herein are for convenience only and do not interpret the scope or meaning of the embodiments.

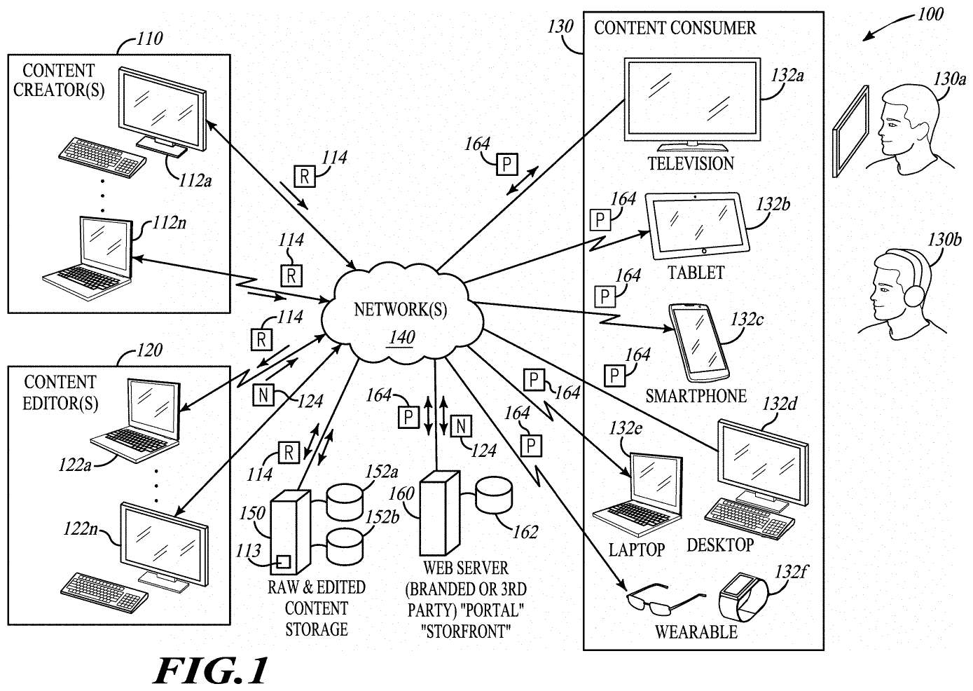

FIG. 1 shows an example network environment 100 in which content creators 110, content editors 120, and media content consumers 130 (e.g., viewers 130a, listeners 130b) are able to create and edit raw content 113 to produce narrative segments 124 that can be assembled into narrative presentations 164, according to an illustrative embodiment. A content creator 110, for example a production team, generates raw (i.e., unedited) content 113 that is edited and assembled into at least one production, for example a narrative presentation 164 by an editing team. This raw content may be generated in analog format (e.g., film images, motion picture film images), digital format (e.g., digital audio recording, digital video recording, digitally rendered audio and/or video recordings, computer generated imagery [“CGI”]). Where at least a portion of the content is in analog format, one or more converter systems or processors convert the analog content to digital format. The production team, using one or more content creator processor-based devices 112a-112n (collectively, “content creator processor-based devices 112”), communicates the content to one or more raw content storage systems 150 via the network 140.

An editing team, serving as content editors 120, accesses the raw content 113 and edits the raw content 113 via a number of processor-based editing systems 122a-122n (collectively “content editing systems processor-based devices 122”) into a number of narrative segments 124. These narrative segments 124 are assembled at the direction of the editing or production teams to form a collection of narrative segments and additional or bonus content that, when combined, comprise a production, for example a narrative presentation 164. The narrative presentation 164 can be delivered to one or more media content consumer processor-based devices 132a-132n (collectively, “media content consumer processor-based devices 132”) either as one or more digital files via the network 140 or via a nontransitory storage media such as a compact disc (CD); digital versatile disk (DVD); or any other current or future developed nontransitory digital data carrier. In some implementations, the one or more of the narrative segments 124 may be streamed via the network 140 to the media content consumer processor-based devices 132.

In some implementations, the media content consumers 130 may access the narrative presentations 164 via one or more media content consumer processor-based devices 132. These media content consumer processor-based devices 132 can include, but are not limited to: televisions or similar image display units 132a, tablet computing devices 132b, smartphones and handheld computing devices 132c, desktop computing devices 132d, laptop and portable computing devices 132e, and wearable computing devices 132f. At times, a single media content consumer 130 may access a narrative presentation 164 across multiple devices and/or platforms. For example, a media content consumer may non-contemporaneously access a narrative presentation 164 using a plurality of media content consumer processor-based devices 132. For example, a media content consumer 130 may consume a narrative presentation 164 to a first point using a television 132a in their living room and then may access the narrative presentation at the first point using their tablet computer 132b or smartphone 132c as they ride in a carpool to work.

At times, the narrative presentation 164 may be stored in one or more nontransitory storage locations 162, for example coupled to a Web server 160 that provides a network accessible portal via network 140. In such an instance, the Web server 160 may stream the narrative presentation 164 to the media content consumer processor-based device 132. For example, the narrative presentation 164 may be presented to the media content consumer 130 on the media content consumer processor-based device 132 used by the media content consumer 130 to access the portal on the Web server 160 upon the receipt, authentication, and authorization of log-in credentials identifying the respective media content consumer 130. Alternatively, the entire narrative presentation 164, or portions thereof (e.g., narrative segments), may be retrieved on an as needed or as requested basis as discrete units (e.g., individual files), rather than streamed. Alternatively, the entire narrative presentation 164, or portions thereof, may be cached or stored on the media content consumer processor-based device 132, for instance before selection of specific narrative segments by the media content consumer 130. On some implementations, one or more content delivery networks (CDNs) may cache narratives at a variety of geographically distributed locations to increase a speed and/or quality of service in delivering the narrative content.

Note that the narrative segment features and relationships discussed may be illustrated in different figures for clarity and ease of discussion. However, some or all of the narrative segment features and relationships are combinable in any way or in any manner to provide additional embodiments. Such additional embodiments generated by combining narrative segment features and relationships fall within the scope of this disclosure.

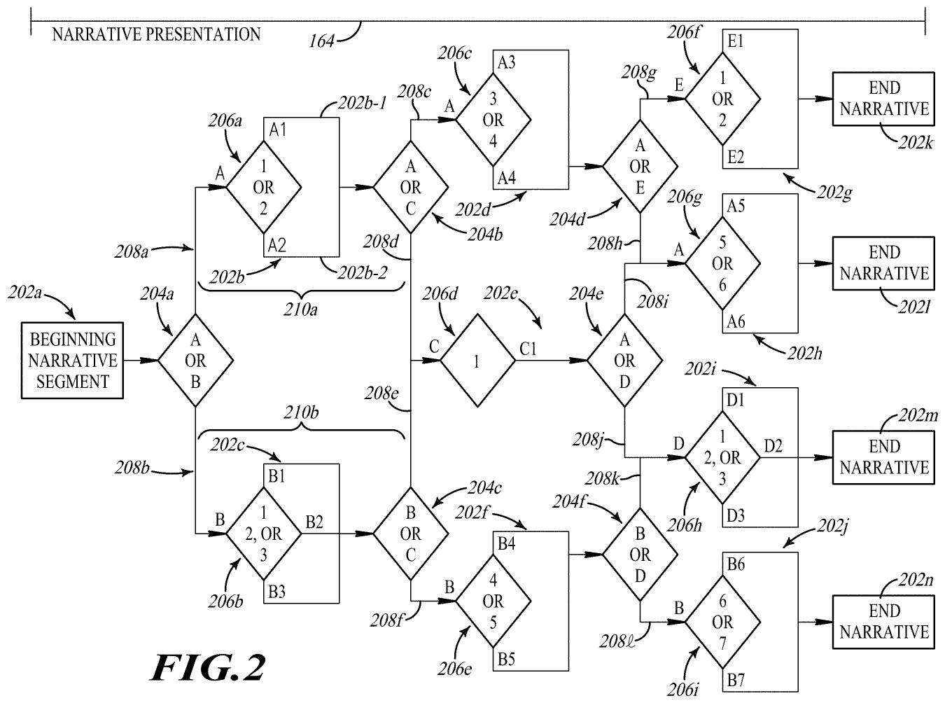

FIG. 2 shows a flow diagram of a production in the form of a narrative presentation 164 comprised of a number of narrative segments 202a-202n (collectively, “narrative segments 202”), a set of path direction prompts 204a-204f (collectively, “narrative prompts 204”), and a set of points 206a-206i (collectively, “points 206”, e.g., path direction decision points).

The narrative presentation 164 may be an interactive narrative presentation 164, in which the media content consumer 130 selects or chooses, or at least influences, a path through the narrative presentation 164. In some implementations, input from the media content consumer 130 may be received, the input representing an indication of the selection or decision by the media content consumer 130 regarding the path direction to take for each or some of the points 206. The user selection or input may be in response to a presentation of one or more user user-selectable interface elements or icons that allow selection between two or more user selectable path direction options for a give point (e.g., path direction decision point).

Optionally, in some implementations, one or more of the content creator processor-based devices 112a-112n, the media content consumer processor-based devices 132a-132n, or other processor-based devices may autonomously generate a selection indicative of the path direction to take for each or some of the points 206 (e.g., path direction decision point). In such an implementation, the choice of path direction for each media content consumer 130 may be made seamlessly without interruption and, or with presentation of a path direction prompt 204 or other selection prompt. Optionally, in some implementations, the autonomously generated path direction selection may be based at least on information that represents one or more characteristics of the media content consumer 130, instead of being based on an input by the media content consumer 130 in response to a presentation of two or more user selectable path direction options.

The media content consumer 130 may be presented with the narrative presentation 164 as a series of narrative segments 202. Narrative segment 202a represents the beginning or foundational narrative segment and narrative segments 202k-202n represent terminal narrative segments that are presented to the media content consumer 130 to end the narrative presentation 164. Note that the events depicted in the terminal narrative segments 202k-202n may occur before, during, or after the events depicted within the foundational narrative segment 202a. By presenting the same beginning or foundational narrative segment 202a, each media content consumer 130 may for example, be introduced to an overarching common story and plotline. Optionally, the narrative presentation 164 may have a single terminal or ending narrative segment 202 (e.g., finale, season finale, narrative finale). In some implementations, each narrative segment 202 may be made available to every media content consumer 130 accessing the narrative presentation 164 and presented to every media content consumer 130 who elects to view such. In some implementations, at least some of the narrative segments 202 may be restricted such as to be presented to only a subset of media content consumers 130. For example, some of the narrative segments 202 may be accessible only by media content consumers 130 who purchase a premium presentation option, by media content consumers 130 who earned access to limited distribution content, for instance via social media sharing actions, or by media content consumers 130 who live in certain geographic locations.

User interface elements, denominated herein as path direction prompts 204, may be incorporated into various points along the narrative presentation 164 at which one path direction among multiple path directions may be chosen in order to proceed through the narrative presentation 164. Path directions are also referred to interchangeably herein as path segments, and represent directions or sub-paths within an overall narrative path. For the most part, path directions selected by the content consumer are logically associated (i.e., relationship defined in a data structure stored in processor-readable memory or storage) with a respective set of narrative segments.

In operation, the system causes presentation of user interface elements or path direction prompts 204. The system receives user input or selections made via the user interface elements or path direction prompts 204. Each user input or selection identifies a media content consumer selected path to take at a corresponding point in the narrative presentation 164.

In one mode of operation, the media content consumer selected path corresponds to or otherwise identifies a specific narrative segment. In this mode of operation, the system causes presentation of the corresponding specific narrative segment in response to selection by the media content consumer of the media content consumer selected path. Optionally in this mode of operation, the system may make a selection of a path direction if the media content consumer does not select a path or provide input within a specified period of time.

In another mode of operation, the media content consumer selected path corresponds to or otherwise identifies a set of two or more narrative segments, which narrative segments in the set are alternative “takes” to one another. For example, each of the narrative segments may have the same story arc, only may only differ in some way that is insubstantial to the story, for instance including a different make and model of vehicle in each of the narrative segments of the set of narrative segments. Additionally or alternatively each narrative segment in the set of narrative segments may include a different drink or beverage. In this mode of operation, for each set of narrative segments, the system can autonomously select a particular narrative segment from the set of two or more narrative segments, based on collected information. The system causes presentation of the corresponding particular narrative segment in response to the autonomous selection from the set, where the set is based on the media content consumer selected path identified by the selection by the media content consumer via the user interface element(s). Optionally in this mode of operation, the system may make a selection of a path direction if the media content consumer does not select a path or provide input within a specified period of time.

For example, at a first point (e.g., first decision point), indicated by the first path direction prompt 204a, a selection or decision may be made between path direction A 208a or path direction B 208b. Path direction A 208a may, for example, be associated with a one set of narrative segments 202b, and path direction B 208b may, for example, be associated with another set of narrative segments 202c. The narrative path portion associated with path direction A 208a may have a path length 210a that extends for the duration of the narrative segment presented from the set of narrative segments 202b. The narrative path portion associated with path direction B 208b may have a path length of 210b that extends for the duration of the narrative segment presented from the set of narrative segments 202c. The path length 210a may or may not be equal to the path length 210b. In some implementations, at least some of the narrative segments 202 subsequent to the beginning or foundational narrative segment 202a represent segments selectable by the media content consumer 130 at the appropriate narrative prompt 204. It is the particular sequence of narrative segments 202 selected by the media content consumer 130 that determines the details and sub-plots (within the context of the overall story and plotline of the narrative presentation 164) experienced or perceived by the particular media content consumer 130. The various path directions 208 may be based upon, for example, various characters appearing in the preceding narrative segment 202, different settings or locations, different time frames, or different actions that a character may take at the conclusion of the preceding narrative segment 202.

As previously noted, each media content consumer selected path can correspond to a specific narrative segment, or may correspond to a set of two or more narrative segments, which are alternative (e.g., alternative “takes”) to one another. As previously noted, for each set of narrative segments that correspond to a selected narrative path direction, the system can select a particular narrative segment from the corresponding set of narrative segments, for instance based at least in part on collected information that represents attributes of the media content consumer.

In some implementations, the multiple path directions available at a path direction prompt 204 may be based on the characters present in the immediately preceding narrative segment 202. For example, the beginning or foundational narrative segment 202a may include two characters “CHAR A” and “CHAR B.” At the conclusion of narrative segment 202a, the media content consumer 130 is presented with the first path direction prompt 204a including icons representative of a subset of available path directions 208 that the media content consumer 130 may choose to proceed through the narrative presentation 164.

The subset of path directions 208 associated with the first path direction prompt 204a may, for example, include path direction A 208a that is logically associated (e.g., mapped in memory or storage media) to a set of narrative segments 202b associated with CHAR A and the path direction B 208b that is logically associated (e.g., mapped in memory or storage media) to a set of narrative segments 202c associated with CHAR B. The media content consumer 130 may select an icon to continue the narrative presentation 164 via one of the available (i.e., valid) path directions 208. If the media content consumer 130 selects the icon representative of the narrative path direction that is logically associated in memory with the set of narrative segments 202b associated with CHAR A at the first path direction prompt 204a, then one of the narrative segments 202 from the set of narrative segment 202b containing characters CHAR A and CHAR C is presented to the media content consumer 130. At the conclusion of narrative segment 202b, the media content consumer is presented with a second path direction prompt 204b requiring the selection of an icon representative of either CHAR A or CHAR C to continue the narrative presentation 164 by following CHAR A in path direction 208c or CHAR C in path direction 208d. Valid paths as well as the sets of narrative segments associated with each valid path may, for example, be defined by the writer, director, and, or the editor of the narrative, limiting the freedom of the media content consumer in return for placing some structure on the overall narrative.

If instead, the media content consumer 130 selects the icon representative of the narrative path direction that is logically associated in memory with the set of narrative segments 202c associated with CHAR B at the first path direction prompt 204a, then one of the narrative segments 202 from the set of narrative segment 202c containing characters CHAR B and CHAR C is presented to the media content consumer 130. At the conclusion of narrative segment 202c, the media content consumer 130 is presented with a third path direction prompt 204c requiring the selection of an icon representative of either CHAR B or CHAR C to continue the narrative presentation 164 by following CHAR B in path direction 208f or CHAR C in path direction 208e. In such an implementation, CHAR C interacts with both CHAR A during the set of narrative segment 202b and with CHAR B during the set of narrative segment 202c, which may occur, for example, when CHAR A, CHAR B, and CHAR C are at a party or other large social gathering. In such an implementation, the narrative segment 202e associated with CHAR C may have multiple entry points, one from the second narrative prompt 204b and one from the third narrative prompt 204c. In some implementations, such as that shown in connection with the fourth point 206d (e.g. segment decision point), at least some points 206 (e.g., path direction decision points) may have only one associated narrative segment 202. In such implementations, the point 206 (e.g., path direction decision points) will present the single associated narrative segment 202 to the media content consumer 130.

Depending on the path directions 208 selected by the media content consumer 130, not every media content consumer 130 is necessarily presented the same number of narrative segments 202, the same narrative segments 202, or the same duration for the narrative presentation 164. A distinction may arise between the number of narrative segments 202 presented to the media content consumer 130 and the duration of the narrative segments 202 presented to the media content consumer 130. The overall duration of the narrative presentation 164 may vary depending upon the path directions 208 selected by the media content consumer 130, as well as the number and/or length of each of the narrative segments 202 presented to the media content consumer 130.

The path direction prompts 204 may allow the media content consumer 130 to choose a path direction they wish to follow, for example specifying a particular character and/or scene or sub-plot to explore or follow. In some implementations, a decision regarding the path direction to follow may be made autonomously by one or more processor-enabled devices, e.g., the content editing systems processor-based devices 122 and/or the media content consumer processor-based devices 132, without a user input that represents the path direction selection or without a user input that that is responsive to a query regarding path direction.

In some instances, the path directions are logically associated with a respective narrative segment 202 or a sequence of narrative segments (i.e., two or more narrative segments that will be presented consecutively, e.g., in response to a single media content consumer selection).

In some implementations, the narrative prompts 204, for example presented at points (e.g., path direction decision points), may be user-actionable such that the media content consumer 130 may choose the path direction, and hence the particular narrative segment to be presented.

In at least some implementations, while each media content consumer 130 may receive the same overall storyline in the narrative presentation 164, because media content consumers 130 may select different respective path directions or narrative segment “paths” though the narrative presentation 164, different media content consumers 130 may have different impressions, feelings, emotions, and experiences, at the conclusion of the narrative presentation 164.

As depicted in FIG. 2, not every narrative segment 202 need include or conclude with a user interface element or narrative prompt 204 containing a plurality of icons, each of which corresponds to a respective media content consumer-selectable narrative segment 202. For example, if the media content consumer 130 selects CHAR A at the fourth narrative prompt 204d, the media content consumer 130 is presented a narrative segment from the set of narrative segments 202h followed by the terminal narrative segment 202l.

At times, at the conclusion of the narrative presentation 164 there may be at least some previously non-selected and/or non-presented path directions or narrative segments 202 which the media content consumers 130 may not be permitted access, either permanently or without meeting some defined condition(s). Promoting an exchange of ideas, feelings, emotions, perceptions, and experiences of media content consumers 130 via social media may beneficially increase interest in the respective narrative presentation 164, increasing the attendant attention or word-of-mouth promotion of the respective narrative presentation 164 among media content consumers 130. Such attention advantageously fosters the discussion and exchange of ideas between media content consumers 130 since different media content consumers take different path directions 208 through the narrative presentation 164, and may otherwise be denied access to one or more narrative segments 202 of a narrative presentation 164 which was not denied to other media content consumers 130. This may create the perception among media content consumers 130 that interaction and communication with other media content consumers 130 is beneficial in better or more fully understanding the respective narrative presentation 164. At least some of the approaches described herein provide media content consumers 130 with the ability to selectively view path directions or narrative segments 202 in an order either completely self-chosen, or self-chosen within a framework of order or choices and/or conditions defined by the production or editing teams. Allowing the production or editing teams to define a framework of order or choices and/or conditions maintains the artistic integrity of the narrative presentation 164 while promoting discussion related to the narrative presentation 164 (and the different path directions 208 through the narrative presentation 164) among media content consumers 130. Social media and social networks such as FACEBOOK®, TWITTER®, SINA WEIBO, FOURSQUARE®, TUMBLR®, SNAPCHAT®, and/or VINE® facilitate such discussion among media content consumers 130.

In some implementations, media content consumers 130 may be rewarded or provided access to previously inaccessible non-selected and/or non-presented path directions or narrative segments 202 contingent upon the performance of one or more defined activities. In some instances, such activities may include generating or producing one or more social media actions, for instance social media entries related to the narrative presentation (e.g., posting a comment about the narrative presentation 164 to a social media “wall”, “liking”, or linking to the narrative, narrative segment 202, narrative character, author or director). Such selective unlocking of non-selected narrative segments 202 may advantageously create additional attention around the respective narrative presentation 164 as media content consumers 130 further exchange communications in order to access some or all of the non-selected path directions or narrative segments 202. At times, access to non-selected path directions or narrative segments 202 may granted contingent upon meeting one or more defined conditions associated with social media or social networks. For example, access to a non-selected path directions or narrative segment 202 may be conditioned upon receiving a number of favorable votes (e.g., FACEBOOK® LIKES) for a comment associated with the narrative presentation 164. Other times, access to non-selected path directions or narrative segments 202 may be granted contingent upon a previous viewing by the media content consumer 130, for instance having viewed a defined number of path directions or narrative segments 202, having viewed one or more particular path directions or narrative segments 202, having followed a particular path direction 208 through the narrative presentation 164. Additionally or alternative, access to non-selected and/or non-presented path directions or narrative segments 202 may be granted contingent upon sharing a path direction or narrative segment 202 with another media content consumer 130 or receiving a path direction or narrative segment 202 or access thereto as shared by another media content consumer with the respective media content consumer.

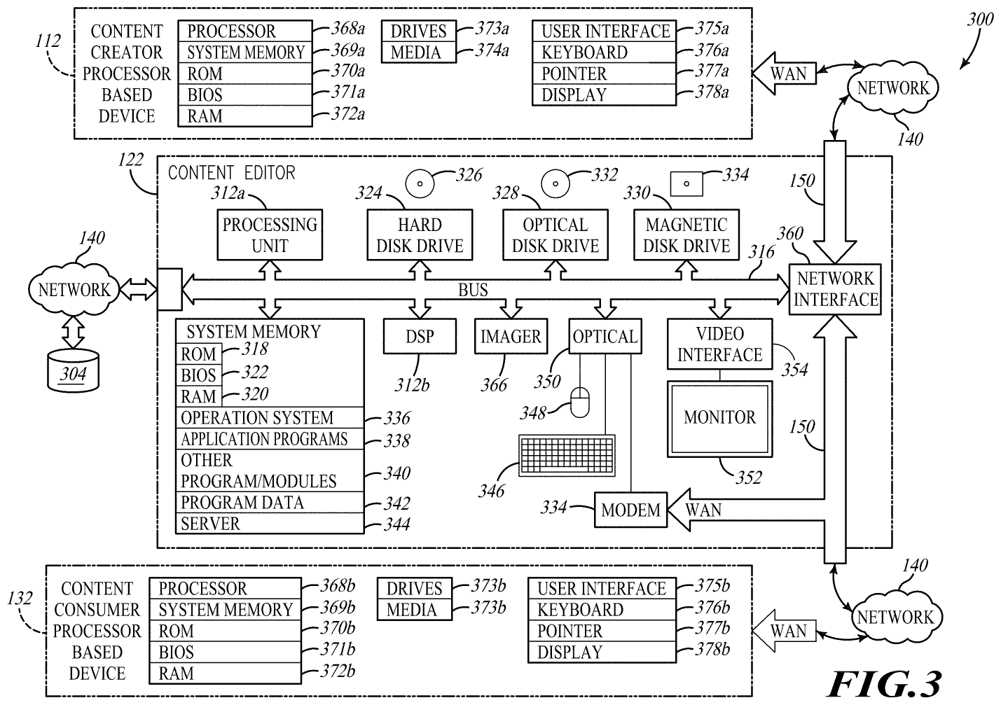

FIG. 3 and the following discussion provide a brief, general description of a suitable processor-based presentation system environment 300 in which the various illustrated embodiments may be implemented. Although not required, the embodiments will be described in the general context of computer-executable instructions, such as program application modules, objects, or macros stored on computer- or processor-readable media and executed by a computer or processor. Those skilled in the relevant arts will appreciate that the illustrated implementations or embodiments, as well as other implementations or embodiments, can be practiced with other processor-based system configurations and/or other processor-based computing system configurations, including hand-held devices, multiprocessor systems, microprocessor-based or programmable consumer electronics, personal computers (“PCs”), networked PCs, mini computers, mainframe computers, and the like. The implementations or embodiments can be practiced in distributed computing environments where tasks or modules are performed by remote processing devices, which are linked through a communications network. In a distributed computing environment, program modules may be located in both local and remote memory storage devices or media.

FIG. 3 shows a processor-based presentation system environment 300 in which one or more content creators 110 provide raw content 113 in the form of unedited narrative segments to one or more content editing system processor-based devices 122. The content editing system processor-based device 122 refines the raw content 113 provided by the one or more content creators 110 into a number of finished narrative segments 202 and logically assembles the finished narrative segments 202 into a narrative presentation 164. A production team, an editing team, or a combined production and editing team are responsible for refining and assembling the finished narrative segments 202 into a narrative presentation 164 in a manner that maintains the artistic integrity of the narrative segment sequences included in the narrative presentation 164. The narrative presentation 164 is provided to media content consumer processor-based devices 132 either as a digital stream via network 140, a digital download via network 140, or stored on one or more non-volatile storage devices such as a compact disc, digital versatile disk, thumb drive, or similar.

At times, the narrative presentation 164 may be delivered to the media content consumer processor-based device 132 directly from one or more content editing system processor-based devices 122. At other times, the one or more content editing system processor-based devices 122 transfers the narrative presentation 164 to a Web portal that provides media content consumers 130 with access to the narrative presentation 164 and may also include one or more payment systems, one or more accounting systems, one or more security systems, and one or more encryption systems. Such Web portals may be operated by the producer or distributor of the narrative presentation 164 and/or by third parties such as AMAZON® or NETFLIX® or YouTube®.

The content editing system processor-based device 122 includes one or more processor-based editing devices 122 (only one illustrated) and one or more communicably coupled nontransitory computer- or processor readable storage medium 304 (only one illustrated) for storing and editing raw narrative segments 114 received from the content creators 110 into finished narrative segments 202 that are assembled into the narrative presentation 164. The associated nontransitory computer- or processor readable storage medium 304 is communicatively coupled to the one or more processor-based editing devices 120 via one or more communications channels. The one or more communications channels may include one or more tethers such as parallel cables, serial cables, universal serial bus (“USB”) cables, THUNDERBOLT® cables, or one or more wireless channels capable of digital data transfer, for instance near field communications (“NFC”), FIREWIRE®, or BLUETOOTH®.

The processor-based presentation system environment 300 also comprises one or more content creator processor-based device(s) 112 (only one illustrated) and one or more media content consumer processor-based device(s) 132 (only one illustrated). The one or more content creator processor-based device(s) 112 and the one or more media content consumer processor-based device(s) 132 are communicatively coupled to the content editing system processor-based device 122 by one or more communications channels, for example one or more wide area networks (WANs) 140. In some implementations, the one or more WANs may include one or more worldwide networks, for example the Internet, and communications between devices may be performed using standard communication protocols, such as one or more Internet protocols. In operation, the one or more content creator processor-based device(s) 112 and the one or more media content consumer processor-based device(s) 132 function as either a server for other computer systems or processor-based devices associated with a respective entity or themselves function as computer systems. In operation, the content editing system processor-based device 122 may function as a server with respect to the one or more content creator processor-based device(s) 112 and/or the one or more media content consumer processor-based device(s) 132.

The processor-based presentation system environment 300 may employ other computer systems and network equipment, for example additional servers, proxy servers, firewalls, routers and/or bridges. The content editing system processor-based device 122 will at times be referred to in the singular herein, but this is not intended to limit the embodiments to a single device since in typical embodiments there may be more than one content editing system processor-based device 122 involved. Unless described otherwise, the construction and operation of the various blocks shown in FIG. 3 are of conventional design. As a result, such blocks need not be described in further detail herein, as they will be understood by those skilled in the relevant art.

The content editing system processor-based device 122 may include one or more processing units 312 capable of executing processor-readable instruction sets to provide a dedicated content editing system, a system memory 314 and a system bus 316 that couples various system components including the system memory 314 to the processing units 312. The processing units 312 include any logic processing unit capable of executing processor- or machine-readable instruction sets or logic. The processing units 312 maybe in the form of one or more central processing units (CPUs), digital signal processors (DSPs), application-specific integrated circuits (ASICs), reduced instruction set computers (RISCs), field programmable gate arrays (FPGAs), logic circuits, systems on a chip (SoCs), etc. The system bus 316 can employ any known bus structures or architectures, including a memory bus with memory controller, a peripheral bus, and/or a local bus. The system memory 314 includes read-only memory (“ROM”) 318 and random access memory (“RAM”) 320. A basic input/output system (“BIOS”) 322, which can form part of the ROM 318, contains basic routines that help transfer information between elements within the content editing system processor-based device 122, such as during start-up.

The content editing system processor-based device 122 may include one or more nontransitory data storage devices. Such nontransitory data storage devices may include one or more hard disk drives 324 for reading from and writing to a hard disk 326, one or more optical disk drives 328 for reading from and writing to removable optical disks 332, and/or one or more magnetic disk drives 330 for reading from and writing to magnetic disks 334. Such nontransitory data storage devices may additionally or alternatively include one or more electrostatic (e.g., solid-state drive or SSD), electroresistive (e.g., memristor), or molecular (e.g., atomic spin) storage devices.

The optical disk drive 328 may include a compact disc drive and/or a digital versatile disk (DVD) configured to read data from a compact disc 332 or DVD 332. The magnetic disk 334 can be a magnetic floppy disk or diskette. The hard disk drive 324, optical disk drive 328 and magnetic disk drive 330 may communicate with the processing units 312 via the system bus 316. The hard disk drive 324, optical disk drive 328 and magnetic disk drive 330 may include interfaces or controllers (not shown) coupled between such drives and the system bus 316, as is known by those skilled in the relevant art. The drives 324, 328 and 330, and their associated computer-readable media 326, 332, 334, provide nonvolatile storage of computer-readable instructions, data structures, program modules and other data for the content editing system processor-based device 122. Although the depicted content editing system processor-based device 122 is illustrated employing a hard disk drive 324, optical disk drive 328, and magnetic disk drive 330, other types of computer-readable media that can store data accessible by a computer may be employed, such as WORM drives, RAID drives, flash memory cards, RAMs, ROMs, smart cards, etc.

Program modules used in editing and assembling the raw narrative segments 114 provided by content creators 110 are stored in the system memory 314. These program modules include modules such as an operating system 336, one or more application programs 338, other programs or modules 340 and program data 342.

Application programs 338 may include logic, processor-executable, or machine executable instruction sets that cause the processor(s) 312 to automatically receive raw narrative segments 114 and communicate finished narrative presentations 164 to a Webserver functioning as a portal or storefront where media content consumers 130 are able to digitally access and acquire the narrative presentations 164. Any current (e.g., CSS, HTML, XML) or future developed communications protocol may be used to communicate either or both the raw narrative segments 114, finished narrative segments 202, and narrative presentations 164 to and from local and/or remote nontransitory storage 152 as well as to communicate narrative presentations 164 to the Webserver.

Application programs 338 may include any current or future logic, processor-executable instruction sets, or machine-executable instruction sets that facilitate the editing, alteration, or adjustment of one or more human-sensible aspects (sound, appearance, feel, taste, smell, etc.) of the raw narrative segments 114 into finished narrative segments 202 by the editing team or the production and editing teams.

Application programs 338 may include any current or future logic, processor-executable instruction sets, or machine-executable instruction sets that facilitate the assembly of finished narrative segments 202 into a narrative presentation 164. Such may include, for example, a narrative assembly editor (e.g., a “Movie Creator”) that permits the assembly of finished narrative segments 202 into a narrative presentation 164 at the direction of the editing team or the production and editing teams. Such may include instructions that facilitate the creation of narrative prompts 204 that appear either during the pendency of or at the conclusion of narrative segments 202. Such may include instructions that facilitate the selection of presentation formats (e.g., split screen, tiles, or lists, among others) for the narrative prompts 204 that appear either during the pendency of or at the conclusion of narrative segments 202.

Specific techniques to create narrative prompts in the form of user-selectable user interface (UI) elements or icons are described elsewhere herein, including the creation and presentation of user-selectable UI elements in a 360 video presentation of a narrative presentation, the user-selectable UI elements advantageously mapped in space and time to various elements of the underlying content in the 360 video presentation. Thus, a user or content consumer may select a path direction to follow through the narrative by selecting (e.g., touching, pointing and clicking) a user selectable icon that, for example is presented overlay at least a portion of the primary content, and which may, for instance visually or graphically resemble a portion of the primary content. For instance, a user-selectable UI element in the form of a user selectable icon may be autonomously generated by the processor-based system or device, the user-selectable UI element which, for instance, resembles an actor or character appearing in the primary content of the narrative presentation. For instance, the system may autonomously generate a user selectable icon, e.g., in outline or silhouette, and autonomously assign a respective visual pattern (e.g., color) to the user selectable icon, and autonomously cause a presentation of the user selectable icon with pattern overlying the actor or character in the narrative presentation, even in a 360 video presentation. While such is generally discussed in terms of being implemented via the content editing system processor-based device 122, many of these techniques can be implemented via other processor-based sub-systems, e.g., content creator processor-based device(s), media content consumer processor-based device(s) 132).

Application programs 338 may additionally include instructions that facilitate the creation of logical or Boolean expressions or conditions that autonomously and/or dynamically create or select icons for inclusion in the narrative prompts 204 that appear either during the pendency of or at the conclusion of narrative segments 202. At times, such logical or Boolean expressions or conditions may be based in whole or in part on inputs representative of actions or selections taken by media content consumers 130 prior to or during the presentation of the narrative presentation 164.

Such application programs may include any current or future logic, processor-executable instruction sets, or machine-executable instruction sets that provide for choosing a narrative segment 202 from a set of narrative segments 202 associated with a point 206 (e.g., segment decision point). In some implementations, a set of one or more selection parameters 308 may be associated with each of the narrative segments 202 in the set of narrative segments 202. The selection parameters 308 may be related to information regarding potential media content consumers 130, such as demographic information, Webpage viewing history, previous narrative presentation 164 viewing history, previous selections at narrative prompts 204, and other such information. The set of selection parameters 308 and associated values may be stored in and accessed from local and/or remote nontransitory storage 152. Each of the selection parameters 308 may have associated values that the application program may compare with collected information associated with a media content consumer 130 to determine the narrative segment 202 to be presented to the media content consumer 130. The application program may determine the narrative segment 202 to present based upon, for example, by selecting the narrative segment 202 with the associated set of values that matches a desired set of values based upon the collected information regarding the media content consumer 130; by selecting the narrative segment 202 with the associated set of values that most closely matches a desired set of values based upon the collected information regarding the media content consumer 130; by selecting the narrative segment with the associated set of values that differ from a desired set of values by more or less than the associated set of values of another of the narrative segments. One or more types of data structures (e.g., a directed acyclic graph) may be used to store the possible (i.e., valid) narrative paths along with the respective sets of possible narrative segments associated with each narrative path.

Such application programs may include any current or future logic, processor-executable instruction sets, or machine-executable instruction sets that facilitate providing media content consumers 130 with access to non-selected narrative segments 202. Such may include logic or Boolean expressions or conditions that include data representative of the interaction of the respective media content consumer 130 with one or more third parties, one or more narrative-related Websites, and/or one or more third party Websites. Such instructions may, for example, collect data indicative of posts made by a media content consumer 130 on one or more social networking Websites as a way to encouraging online discourse between media content consumers 130 regarding the narrative presentation 164.

Such application programs may include any current or future logic, processor-executable instruction sets, or machine-executable instruction sets that facilitate the collection and generation of analytics or analytical measures related to the sequences of narrative segments 202 selected by media content consumers 130. Such may be useful for identifying a “most popular” narrative segment sequence, a “least viewed” narrative segment sequence, a “most popular” narrative segment 202, a “least popular” narrative segment, a time spent viewing a narrative segment 202 or the narrative presentation 164, etc.

Other program modules 340 may include instructions for handling security such as password or other access protection and communications encryption. The system memory 314 may also include communications programs, for example a server that causes the content editing system processor-based device 122 to serve electronic or digital documents or files via corporate intranets, extranets, or other networks as described below. Such servers may be markup language based, such as Hypertext Markup Language (HTML), Extensible Markup Language (XML) or Wireless Markup Language (WML), and operate with markup languages that use syntactically delimited characters added to the data of a document to represent the structure of the document. A number of suitable severs may be commercially available such as those from MOZILLA®, GOOGLE®, MICROSOFT®, and APPLE COMPUTER®.

While shown in FIG. 3 as being stored in the system memory 314, the operating system 336, application programs 338, other programs/modules 340, program data 342 and browser 344 may be stored locally, for example on the hard disk 326, optical disk 332 and/or magnetic disk 334. At times, other programs/modules 340, program data 342 and browser 344 may be stored remotely, for example on one or more remote file servers communicably coupled to the content editing system processor-based device 122 via one or more networks such as the Internet.

A production team or editing team member enters commands and data into the content editing system processor-based device 122 using one or more input devices such as a touch screen or keyboard 346 and/or a pointing device such as a mouse 348, and/or via a graphical user interface (“GUI”). Other input devices can include a microphone, joystick, game pad, tablet, scanner, etc. These and other input devices are connected to one or more of the processing units 312 through an interface 350 such as a serial port interface that couples to the system bus 316, although other interfaces such as a parallel port, a game port or a wireless interface or a Universal Serial Bus (“USB”) can be used. A monitor 352 or other display device couples to the system bus 316 via a video interface 354, such as a video adapter. The content editing system processor-based device 122 can include other output devices, such as speakers, printers, etc.

The content editing system processor-based device 122 can operate in a networked environment using logical connections to one or more remote computers and/or devices. For example, the content editing system processor-based device 122 can operate in a networked environment using logical connections to one or more content creator processor-based device(s) 112 and, at times, one or more media content consumer processor-based device(s) 132. Communications may be via tethered and/or wireless network architecture, for instance combinations of tethered and wireless enterprise-wide computer networks, intranets, extranets, and/or the Internet. Other embodiments may include other types of communications networks including telecommunications networks, cellular networks, paging networks, and other mobile networks. There may be any variety of computers, switching devices, routers, bridges, firewalls and other devices in the communications paths between the content editing system processor-based device 122 and the one or more content creator processor-based device(s) 112 and the one or more media content consumer processor-based device(s) 132.

The one or more content creator processor-based device(s) 112 and the one or more media content consumer processor-based device(s) 132 will typically take the form of processor-based devices, for instance personal computers (e.g., desktop or laptop computers), netbook computers, tablet computers and/or smartphones and the like, executing appropriate instructions. At times, the one or more content creator processor-based device(s) 112 may include still or motion picture cameras or other devices capable of acquiring data representative of human-sensible data (data indicative of sound, sight, smell, taste, or feel) that are capable of directly communicating data to the content editing system processor-based device 122 via network 140. At times, some or all of the one or more content creator processor-based device(s) 112 and the one or more media content consumer processor-based device(s) 132 may communicably couple to one or more server computers. For instance, the one or more content creator processor-based device(s) 112 may communicably couple via one or more remote Webservers that include a data security firewall. The server computers may execute a set of server instructions to function as a server for a number of content creator processor-based device(s) 112 (i.e., clients) communicatively coupled via a LAN at a facility or site. The one or more content creator processor-based device(s) 112 and the one or more media content consumer processor-based device(s) 132 may execute a set of client instructions and consequently function as a client of the server computer(s), which are communicatively coupled via a WAN.

The one or more content creator processor-based device(s) 112 and the one or more media content consumer processor-based device(s) 132 may each include one or more processing units 368a, 368b (collectively “processing units 368”), system memories 369a, 369b (collectively, “system memories 369”) and a system bus (not shown) that couples various system components including the system memories 369 to the respective processing units 368. The one or more content creator processor-based device(s) 112 and the one or more media content consumer processor-based device(s) 132 will at times each be referred to in the singular herein, but this is not intended to limit the embodiments to a single content creator processor-based device 112 and/or a single media content consumer processor-based device 132. In typical embodiments, there may be more than one content creator processor-based device 112 and there will likely be a large number of media content consumer processor-based devices 132. Additionally, one or more intervening data storage devices, portals, and/or storefronts not shown in FIG. 3 may be present between the content editing system processor-based device 122 and at least some of the media content consumer processor-based devices 132.

The processing units 368 may be any logic processing unit, such as one or more central processing units (CPUs), digital signal processors (DSPs), application-specific integrated circuits (ASICs), logic circuits, reduced instruction set computers (RISCs), field programmable gate arrays (FPGAs), etc. Non-limiting examples of commercially available computer systems include, but are not limited to, an i3, i5, and i7 series microprocessors available from Intel Corporation, U.S.A., a Sparc microprocessor from Sun Microsystems, Inc., a PA-RISC series microprocessor from Hewlett-Packard Company, an A9, A10, A11, or A12 series microprocessor available from Apple Computer, or a Snapdragon processor available from Qualcomm Corporation. Unless described otherwise, the construction and operation of the various blocks of the one or more content creator processor-based device(s) 112 and the one or more media content consumer processor-based device(s) 132 are of conventional design. As a result, such blocks need not be described in further detail herein, as they will be understood by those skilled in the relevant arts.

The system bus can employ any known bus structures or architectures, including a memory bus with memory controller, a peripheral bus, and a local bus. The system memory 369 includes read-only memory (“ROM”) 370a, 370b (collectively 370) and random access memory (“RAM”) 372a, 372b (collectively 372). A basic input/output system (“BIOS”) 371a, 371b (collectively 371), which can form part of the ROM 370, contains basic routines that help transfer information between elements within the one or more content creator processor-based device(s) 112 and the one or more media content consumer processor-based device(s) 132, such as during start-up.

The one or more content creator processor-based device(s) 112 and the one or more media content consumer processor-based device(s) 132 may also include one or more media drives 373a, 373b (collectively 373), e.g., a hard disk drive, magnetic disk drive, WORM drive, and/or optical disk drive, for reading from and writing to computer-readable storage media 374a, 374b (collectively 374), e.g., hard disk, optical disks, and/or magnetic disks. The computer-readable storage media 374 may, for example, take the form of removable non-transitory storage media. For example, hard disks may take the form of a Winchester drives, and optical disks can take the form of CD-ROMs, while electrostatic nontransitory storage media may take the form of removable USB thumb drives. The media drive(s) 373 communicate with the processing units 368 via one or more system buses. The media drives 373 may include interfaces or controllers (not shown) coupled between such drives and the system bus, as is known by those skilled in the relevant art. The media drives 373, and their associated computer-readable storage media 374, provide nonvolatile storage of computer readable instructions, data structures, program modules and other data for the one or more content creator processor-based devices 112 and/or the one or more media content consumer processor-based devices 132. Although described as employing computer-readable storage media 374 such as hard disks, optical disks and magnetic disks, those skilled in the relevant art will appreciate that one or more content creator processor-based device(s) 112 and/or one or more media content consumer processor-based device(s) 132 may employ other types of computer-readable storage media that can store data accessible by a computer, such as flash memory cards, digital video disks (“DVD”), RAMs, ROMs, smart cards, etc. Data or information, for example, electronic or digital documents or files or data (e.g., metadata, ownership, authorizations) related to such can be stored in the computer-readable storage media 374.

Program modules, such as an operating system, one or more application programs, other programs or modules and program data, can be stored in the system memory 369. Program modules may include instructions for accessing a Website, extranet site or other site or services (e.g., Web services) and associated Web pages, other pages, screens or services hosted by components communicatively coupled to the network 140.

Program modules stored in the system memory of the one or more content creator processor-based devices 112 include any current or future logic, processor-executable instruction sets, or machine-executable instruction sets that facilitate the collection and/or communication of data representative of raw narrative segments 114 to the content editing system processor-based device 122. Such application programs may include instructions that facilitate the compression and/or encryption of data representative of raw narrative segments 114 prior to communicating the data representative of the raw narrative segments 114 to the content editing system processor-based device 122.

Program modules stored in the system memory of the one or more content creator processor-based devices 112 include any current or future logic, processor-executable instruction sets, or machine-executable instruction sets that facilitate the editing of data representative of raw narrative segments 114. For example, such application programs may include instructions that facilitate the partitioning of a longer narrative segment 202 into a number of shorter duration narrative segments 202.

Program modules stored in the one or more media content consumer processor-based device(s) 132 include any current or future logic, processor-executable instruction sets, or machine-executable instruction sets that facilitate the presentation of the narrative presentation 164 to the media content consumer 130.

The system memory 369 may also include other communications programs, for example a Web client or browser that permits the one or more content creator processor-based device(s) 112 and the one or more media content consumer processor-based device(s) 132 to access and exchange data with sources such as Web sites of the Internet, corporate intranets, extranets, or other networks. The browser may, for example be markup language based, such as Hypertext Markup Language (HTML), Extensible Markup Language (XML) or Wireless Markup Language (WML), and may operate with markup languages that use syntactically delimited characters added to the data of a document to represent the structure of the document.

While described as being stored in the system memory 369, the operating system, application programs, other programs/modules, program data and/or browser can be stored on the computer-readable storage media 374 of the media drive(s) 373. A content creator 110 and/or media content consumer 130 enters commands and information into the one or more content creator processor-based device(s) 112 and the one or more media content consumer processor-based device(s) 132, respectively, via a user interface 375a, 375b (collectively “user interface 375”) through input devices such as a touch screen or keyboard 376a, 376b (collectively “input devices 376”) and/or a pointing device 377a, 377b (collectively “pointing devices 377”) such as a mouse. Other input devices can include a microphone, joystick, game pad, tablet, scanner, etc. These and other input devices are connected to the processing unit 369 through an interface such as a serial port interface that couples to the system bus, although other interfaces such as a parallel port, a game port or a wireless interface or a universal serial bus (“USB”) can be used. A display or monitor 378a, 378b (collectively 378) may be coupled to the system bus via a video interface, such as a video adapter. The one or more content creator processor-based device(s) 112 and the one or more media content consumer processor-based device(s) 132 can include other output devices, such as speakers, printers, etc.

360 videos are regular video files of high resolution (e.g., at least 1920×1080 pixels). However, images are recorded with a projection distortion, which allows projection of all 360 degree angles onto a flat, two-dimensional surface. A common projection is called an equirectangular Projection.

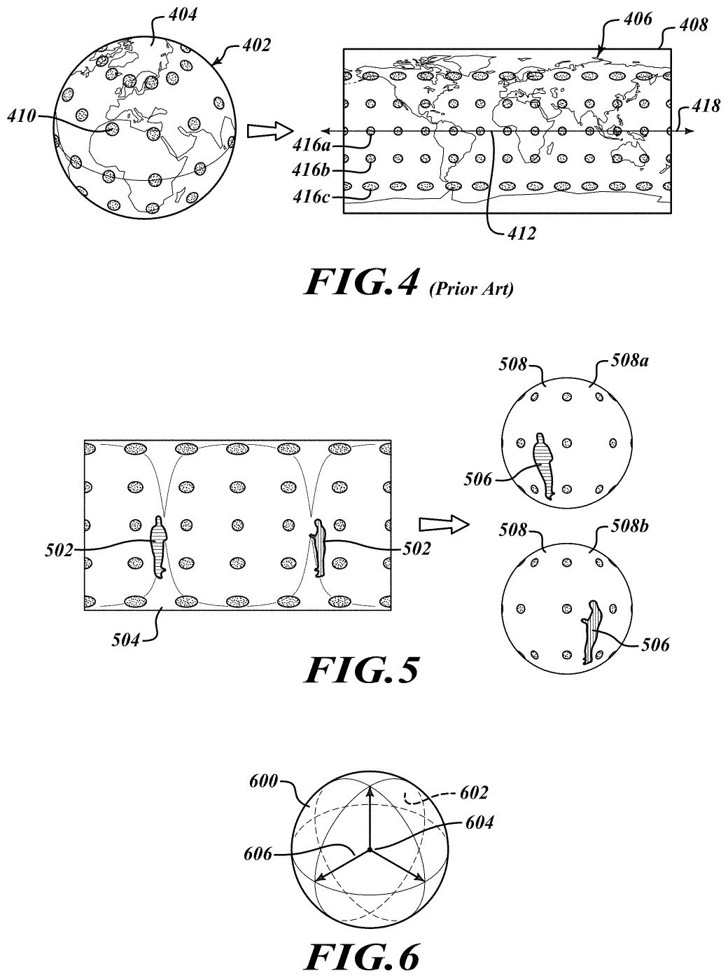

One approach described herein takes a 360 video that uses an equirectangular projection, and undistorts the images by applying the video back onto an inner or interior surface of a hollow virtual sphere. This can be accomplished by applying a video texture onto the inner or interior surface of the virtual sphere, which, for example, wraps the virtual sphere entirely, un-doing the projection distortion. This is illustrated in, and described with respect to, FIGS. 4 and 5 below.

In order to create an illusion that the viewer is within the 360 video, virtual camera is positioned at a center of the virtual sphere, and a normal of the video texture is flipped from what would typically be conventional, since the three-dimensional surface is concave rather than convex. This allows us to trick the 3D system into displaying the video on the inside of the sphere, rather than the outside, giving us the illusion of immersion. The virtual camera is typically controlled by the viewer to be able to see portions of undistorted video on a display device. This is best illustrated in, and described with reference to FIG. 6 below.

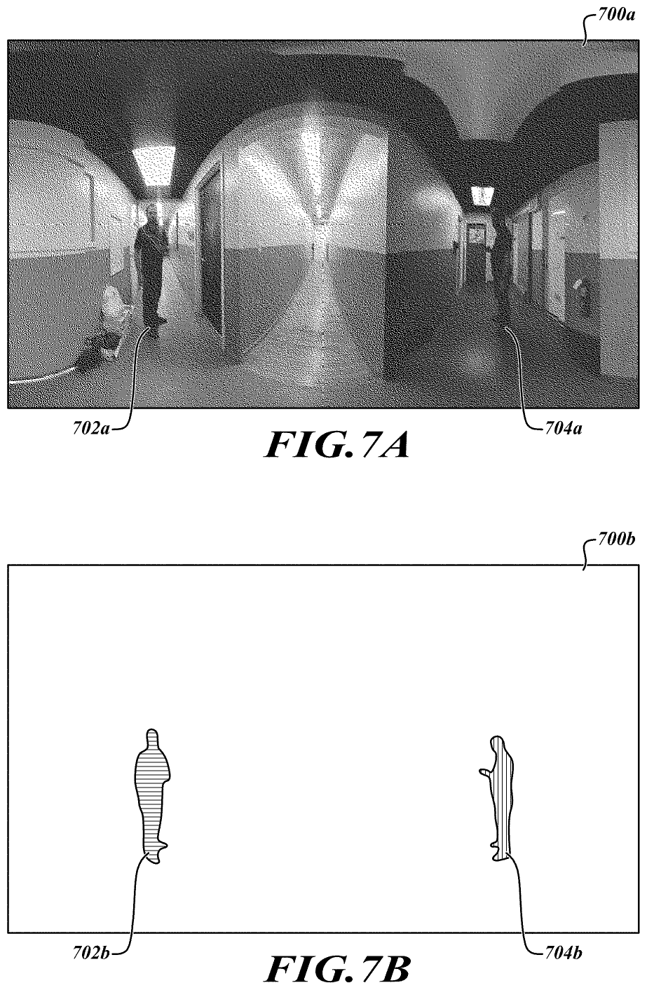

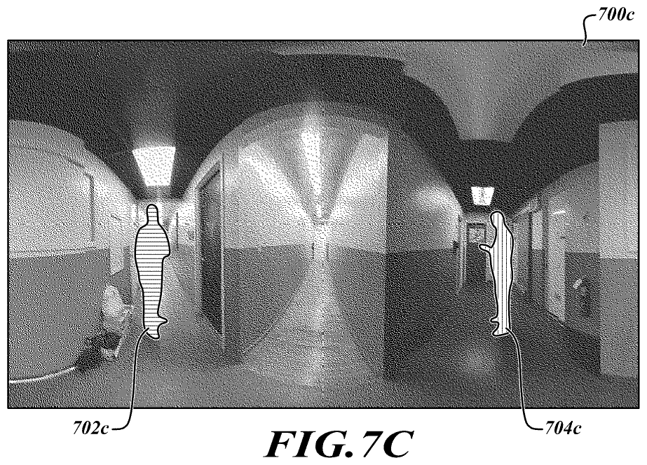

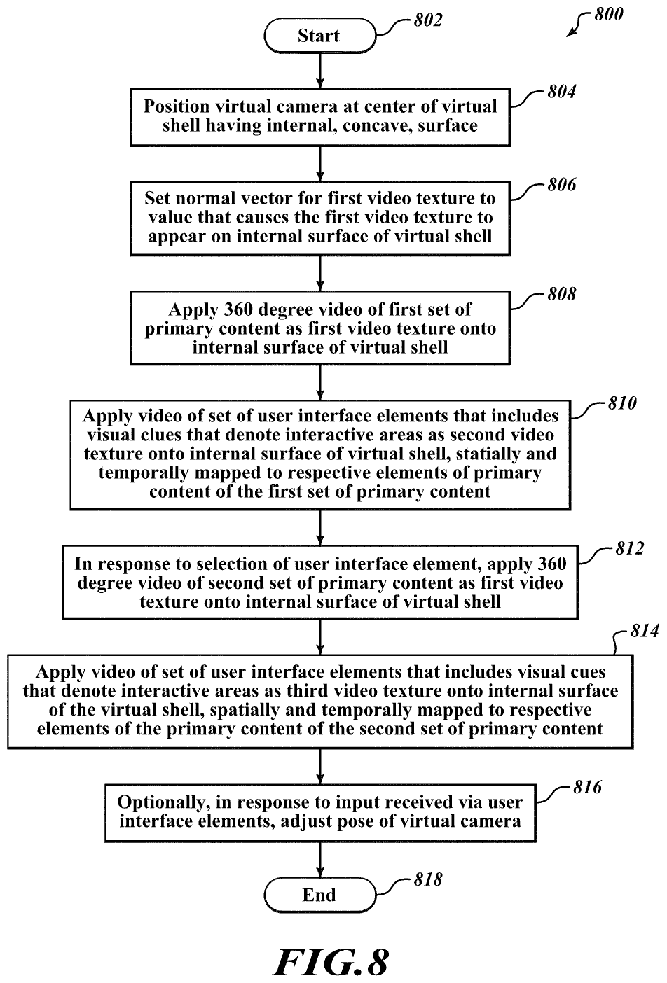

Three-dimensional game engines (e.g., SceneKit®) typically allow developers to combine a piece of content's visual properties with lighting and other information. This can be advantageously employed to address the current problems, by controlling various visual effects to provide useful user interface elements in the context of primary content (e.g., narrative presentation). For instance, different colors, images and even videos can be employed to lighten, darken, and/or apply special textures onto select regions in a frame or set of frames, for instance applying such visual effects on top of and/or as part of the original texture of the primary content. As described herein, a similar process can be employed to denote interactive areas, applying a separate video that contains the user interface elements, for instance visual effects (e.g., highlighting), onto the primary content video, rendering both at the same time and in synchronization over time both temporally and spatially. Such is best illustrated in, and described with reference to, FIGS. 7A-7C and 8 below.

To select an interactive area, a user or viewer using a touch screen display may touch the corresponding area on the touch screen display, or alternatively place a cursor in the corresponding area and execute a selection action (e.g. press a button on a pointing device, for instance a computer mouse). In response, a processor-based system casts a ray from the device, through the virtual camera that's positioned at the center of the virtual shell (e.g., virtual spherical shell), outwards into infinity. This ray will intersect the virtual shell at some location on the virtual shell. Through this point of intersection, the processor-based system can extract useful data about to the user interface element, user icon, visually distinct (e.g., highlights) portion or the portion of the narrative presentation at the point of intersection. For example, the processor-based system may determine a pixel color value of the area through which the ray passes. Apple's SceneKit® allows filtering out the original video frame, leaving only the pixel values of the user interface elements, user icons, visually distinct (e.g., highlights) portions or the portions of the narrative presentation. Since there is a one-to-one mapping between the pixel value and an action, a call can be made, for example a call to a lookup table to determine a corresponding action. The processor-based system may optionally analyze the identified action to be performed, and ascertain whether or not the action is possible in the current scenario or situation. If the action is possible or available, the processor-based system may execute the identified action, for example moving to a new narrative segment.

The approach described herein advantageously minimizes or eliminates the need for any external virtual interactive elements that would need to be synchronized in three-dimensions with respect to the original 360 video. The approach does pose at least one complication or limitation, which is simpler to solve than synchronizing external virtual interactive elements with the original 360 video. In particular, under the approach described herein, the UI/UX visually represents the interactive areas as highlights, which affects how the designer(s) approaches the UI/UX of any 360 video application.

FIG. 4 illustrates a transformation or mapping of an image 402 from a three-dimensional space or three-dimensional surface 404 to an image 406 in a two-dimensional space or two-dimensional surface 408 according to a conventional technique. Such is illustrated to provide background understanding only.

The image 402 in three-dimensional space or three-dimensional surface 404 may be used to represent of frame of a 360 video. There are various transformations that are known for transforming between a representation in three-dimensional space or three-dimensional space surface to a representation in two-dimensional space or two-dimensional surface. For example, the illustrated conventional transformation is called an equirectangular projection.

Notably, the equirectangular projection, like many transformations, results in some distortion. The distortion is apparent by comparing the size of land masses 410 (only one called out) between the three-dimensional space or three-dimensional surface 404 representation with those same land masses 412 (only one called out) in two-dimensional space or two-dimensional surface 408 representation. The distortion is further illustrated by the addition of circular and elliptical patterns on both the three-dimensional space or three-dimensional surface representation and the two-dimensional space or two-dimensional surface representation. Notably, in the three-dimensional space or three-dimensional surface 404 representation the surface is covered with circular patterns 414a, 414b, 414c (only three called out, collectively 414) that are of equal radii without regard to the particular location on the three-dimensional space or three-dimensional surface 440. In contrast, in two-dimensional space or two-dimensional surface 408 representation circular patterns 416a (only one called out, collectively 414) appear only along a horizontally extending centerline (e.g., corresponding to the equator) 418, and increasingly elliptical patterns 416b, 416c (only two called out) appear as one moves perpendicularly (e.g., vertically) away from the horizontally extending centerline 418. Thus, the “unfolding” of the image from the spherical surface 404 to a flat surface 406 results in distortion, some portions of the image appearing larger relative to other portions in the two-dimensional representation than those portions would appear in the three-dimensional (e.g., spherical) representation.

FIG. 5 shows a transformation or mapping of an image 502 from a two-dimensional space or two-dimensional surface 504 to an image 506 in a three-dimensional space or three-dimensional surface 506, for example to an interior or inner surface 506a, 506b of a virtual spherical shell 508, the three dimensional space represented as two hemispheres 508a, 508b of the virtual spherical shell 508 for ease of illustration, according to one illustrated implementation.

Notably, the transformations from a two-dimensional space or surface to a three-dimensional space or surface results in some distortion. This is illustrated by the addition of circular and elliptical patterns on both the three-dimensional space or three-dimensional surface representation and the two-dimensional space or two-dimensional surface representation.

FIG. 6 shows a representation of a virtual shell 600, according to one illustrated implementation.

The virtual shell 600 includes an inner surface 602. The inner surface 602 may be a closed surface, and may be concave.

As illustrated, at least one component (e.g., processor) of the system implements a virtual camera represented by orthogonal axes 606 in a pose at a center 606 of the virtual shell 600. Where the virtual shell 600 is a virtual spherical shell, the center 606 may be a point that is equidistance from all points on the inner surface 602 of the virtual shell 600. The pose of the virtual camera 606 may represent a position in three-dimensional space relative to the inner surface 602 of the virtual shell. The pose may additionally representation a three-dimensional orientation of the virtual camera 606, for instance represented a respective orientation or rotation about each axis of a set of orthogonal axes located at a center point 606 of the virtual shell 600. For instance, a pose of the virtual camera 606 may be represented by the respective orientation of the orthogonal axes 606 relative to a coordinate system of the virtual shell 600. User input can, for example, be used to modify the pose of the virtual camera 606, for instance to view a portion of the 360 video environment that would not otherwise be visible without reorienting or repositioning the virtual camera 606. Thus, a content consumer or viewer can manipulate the field of view to look left, right, up, down, and even behind a current field of view.

FIG. 7A-7C illustrate sequential operations to generate user-selectable user interface elements and map the generated user interface elements to be displayed in registration with respective content in a narrative presentation, according to at least one illustrated implementation.

In particular, FIG. 7A shows a frame of 360 video 700a without user interface elements or user selectable icons. In the frame of 360 video 700a two actors or characters 702a, 704a are visible. In this narrative presentation, each actor or character is logically represented with a respective path to the next segment of the narrative presentation. For instance, a first path follows one of the other of the actors or characters and a second path follows the other one of the other of the actors or characters. The system will generate and cause the display of one or more user-selectable UI elements or icons, which when selected by a user, viewer or content consumer, causes a presentation of a next segment according to the corresponding path selected by the user, viewer or content consumer.

While the user-selectable UI elements or icons are illustrated and described with respect respective actors or characters, this approach can be applied to other elements in the narrative presentation, whether animate or inanimate objects. In some implementations, one or more user-selectable UI elements or icons may be unassociated with any particular person, animal or object in the presentation, but may, for instance appear to reside in space.

FIG. 7B shows a frame of an image 700b with the same dimensions as the frame of 360 video 700a illustrated in FIG. 7A. This frame includes a pair of outlines, profiles or silhouettes 702b, 704b of actors or characters that appear in the frame of 360 video 700a illustrated in FIG. 4A, in the same poses as they appear in the frame of 360 video 700a. The outlines, profiles or silhouettes 702b, 704b of actors or characters may be automatically or autonomously rotoscoped from the frame of 360 video 700a illustrated in FIG. 4A via the processor-based system. The outlines, profiles or silhouettes 702b, 704b are the advantageously receive a visual treatment that makes the outlines, profiles or silhouettes 702b, 704b unique from one another. For example, each outlines, profiles or silhouettes 702b, 704b is filled in with a respective color, shading or highlighting. The environment surrounding the outlines, profiles or silhouettes 702b, 704b may be painted white or otherwise rendered in a fashion as to eliminate or diminish an appearance of the environment surrounding the outlines, profiles or silhouettes 702b, 704b.

FIG. 7C shows a frame of 360 video 700c which includes image user-selectable UI elements or icons 702c, 702c, according to at least one illustrated implementation.

The processor-based system may generate the frame of 360 video 700c by, for example compositing (e.g., multiplying) the original frame of 360 video 700a (FIG. 7A) without any user-selectable UI elements or icons with the autonomously generated user-selectable UI elements or icons 702c, 702c (FIG. 7B).

The user-selectable UI elements or icons 702c, 702c may, for example, comprise profiles, outlines or silhouettes of actors or characters, preferably with a visual treatment (e.g., unique color fill). All interactive areas advantageously have a unique visual treatment (e.g., color that is unique within a frame of the narrative presentation). For example every interactive area identified via a respective user-selectable UI element or icon may have a unique red/green/blue (RGB) value. This can guarantee a one-to-one mapping between an interactive area and a respective action (e.g., selection of a respective narrative path segment). Using simple Web RGB values allows up to 16,777,216 simultaneously rendered interactive areas to be uniquely assigned.

All of the operations illustrated in FIGS. 7A-7C may be automatically performed via the processor-based system or autonomously performed by the processor-based system.

FIG. 8 shows a high-level method 800 of operation of a system to present narrative segments 202 to a media content consumer 130, according to at least one implementation. The method 800 may be executed by one or more processor-enabled devices, such as, for example, the media content consumer processor-based device 132 and/or a networked server(s), such as Webserver 160. In some implementations, the method 800 may be executed by multiple such processor-enabled devices.

The method 800 starts at 802 for example, in response to power the processor-based system, invoking a program, subroutine or function, or for instance, in response to a user input.

At 504, at least one component (e.g., processor) of the processor-based system positions a virtual camera at a center of a virtual shell having internal surface. The internal surface may, for example take the form of a concave surface.

At 506, at least one component (e.g., processor) of the processor-based system sets a normal vector for a first video texture to a value that causes the first video texture to appear on at least a portion of the internal surface of the virtual shell. Setting a normal vector for the first video texture to a value that causes the first video texture to appear on the internal surface of the virtual shell may include changing a default value of the normal vector for the video texture.

At 508, at least one component (e.g., processor) of the processor-based system applies a 360 degree video of a first set of primary content as a first video texture onto the internal surface of the virtual shell.

Applying the first video texture may include applying the first video texture onto an entirety of the internal surface of the virtual spherical shell. Applying the first video texture may include applying the first video texture onto an entirety of the internal surface of a virtual closed spherical shell. Applying a 360 degree video of a first set of primary content as a first video texture onto at least a portion of the internal surface of the virtual shell undoes a projection distortion of the 360 video, for example undoing or removing an equirectangular projection distortion of from 360 video. Applying a 360 degree video of a first set of primary content as a first video texture onto at least a portion of the internal surface of the virtual shell may include applying a monoscopic 360 degree video of the first set of primary content as the first video texture onto at least the portion of the internal surface of the virtual shell.

At 510, at least one component (e.g., processor) of the processor-based system applies a video of a set of user interface elements as a second video texture onto at least a portion of the internal surface of the virtual shell. The set of user interface elements includes visual cues that denote interactive areas. The set of user interface elements, are spatially and temporally mapped to respective elements of the primary content of the first set of primary content.

In at least one implementation, at least one of the visual cues is a first color and applying a video of a set of user interface elements includes applying the video of the set of user interface elements that includes the first color as a first one of the visual cues and that denotes a first interactive area as the second video texture onto at least the portion of the internal surface of the virtual shell.

In at least one implementation, at least one of the visual cues is a first image and applying a video of a set of user interface elements includes applying the video of the set of user interface elements that includes the first image as a first one of the visual cues and that denotes a first interactive area as the second video texture onto at least the portion of the internal surface of the virtual shell.

In at least one implementation, at least one of the visual cues is a first video cue comprising a sequence of images and applying a video of a set of user interface elements and applying the video of the set of user interface elements that includes visual cues includes applying the first video cue as a first one of the visual cues that denotes a first interactive area as the second video texture onto at least the portion of the internal surface of the virtual shell.

In at least one implementation, at least one of the visual cues is a first outline of a first character that appears in the primary content. Applying a video of a set of user interface elements as a second video texture onto at least a portion of the internal surface of the virtual shell includes applying the video of the set of user interface elements that includes the first outline of the first character as the first one of the visual cues which denotes a first interactive area.

In at least one implementation, at least one of the visual cues comprises a first outline of a first character that appears in the primary content with an interior of the first outline filled with a first color. Applying a video of a set of user interface elements as a second video texture onto at least a portion of the internal surface of the virtual shell includes applying the video of the set of user interface elements that includes the first outline of the first character filled with the first color as the first one of the visual cues which denotes a first interactive area.

In at least one implementation, a first one of the visual cues comprises a first outline of a first character that appears in the primary content with an interior of the first outline filled with a first color and a second one of the visual cues is a second outline of a second character that appears in the primary content with an interior of the second outline filled with a second color, the second character different from the first character. Applying a video of a set of user interface elements as a second video texture onto at least a portion of the internal surface of the virtual shell includes applying the video of the set of user interface elements that includes the first outline of the first character filled with the first color and the second outline of the second character filled with the second color which respectively denote a first interactive area and a second interactive area.

In at least one implementation, at least one of the visual cues comprises a first outline of a first character that appears in the primary content with an interior of the first outline filled with a first color, at least one of the visual cues is a second outline of a second character that appears in the primary content with an interior of the second outline filled with a second color, the second character different from the first character. Applying a video of a set of user interface elements as a second video texture onto at least a portion of the internal surface of the virtual shell includes applying the video of the set of user interface elements that includes the first outline of the first character filled with the first color and the second outline of the second character filled with the second color as a first one and a second one of the visual cues and that respectively denote a first interactive area and a second interactive area.

In at least one implementation, a number of the visual cues comprises a respective outline of each of a number one or more characters that appear in the primary content. Applying a video of a set of user interface elements as a second video texture onto at least a portion of the internal surface of the virtual shell comprises applying the video of the set of user interface elements that includes the outlines of the characters as respective ones of the visual cues and that respectively denote respective ones of a number of interactive areas.

In at least one implementation, a number of the visual cues comprises a respective outline of each of a number one or more characters that appear in the primary content. Applying a video of a set of user interface elements as a second video texture onto at least a portion of the internal surface of the virtual shell includes applying the video of the set of user interface elements that includes the outlines of the characters filled with a respective unique color from a set of colors as respective ones of the visual cues and that respectively denote respective ones of a number of interactive areas.

In at least one implementation, applying a video of a set of user interface elements that includes visual cues that denote interactive areas as a second video texture onto at least a portion of the internal surface of the virtual shell comprises applying the video of the set of user interface elements that includes a visual treatment that at least partially obscures any of the primary content of the first set of primary content that appears in any area outside of any of the respective outlines of each of the number of characters that appear in the primary content. Applying the video of the set of user interface elements that includes a visual treatment that at least partially obscures any of the primary content of may include applying the video of the set of user interface elements that includes a translucent visual treatment over any area outside of any of the respective outlines of each of the number of characters that appear in the primary content. Applying the video of the set of user interface elements that includes a visual treatment that at least partially obscures any of the primary content of may include applying the video of the set of user interface elements that includes an opaque visual treatment over any area outside of any of the respective outlines of each of the number of characters that appear in the primary content that completely obscures some of the primary content.

At 512, in response to selection of user interface element at least one component (e.g., processor) of the processor-based system applies a 360 degree video of a second set of primary content as a new first video texture onto the internal surface of the virtual shell.

At 514, at least one component (e.g., processor) of the processor-based system applies a video of set of user interface elements onto at least a portion of the internal surface of the virtual shell. The set of user interface elements includes visual cues that denote interactive areas. The set of user interface elements, are spatially and temporally mapped to respective elements of the primary content of the first set of primary content. The users interface elements of the set of users interface elements may be the same as those previously displayed. Alternatively, one, more or all of the users interface elements of the set may be different from those previously displayed.

Optionally, at 516, in response to input received via user interface elements at least one component (e.g., processor) of the processor-based system adjusts a pose of the virtual camera. Adjusting a pose of the virtual camera can include adjust an orientation or view point of the virtual camera, for example in three-dimensional virtual space. Adjusting a pose of the virtual camera can include adjust position of the virtual camera, for example in three-dimensional virtual space.

While not expressly illustrated, at least one component (e.g., processor) of the system can cause a presentation of a narrative segment 202 of a narrative presentation 164 to a media content consumer 130 along with the user interface elements (e.g., visual indications of interactive portions of the narrative segment 202), which are in some cases referred to herein as narrative prompts. For example, the at least one component can stream a narrative segment to a media content consumer device. Also for example, an application executing on a media content consumer device may cause a presentation of a narrative segment via one or more output components (e.g., display, speakers, haptic engine) of a media content consumer device. The narrative segment may be stored in non-volatile memory on the media content consumer device, or stored externally therefrom and retrieved or received thereby, for example via a packet delivery protocol. The presented narrative segment may, for example, be a first narrative segment of the particular production (e.g., narrative presentation), which may be presented to all media content consumers of the particular production, for example to establish a baseline of a narrative.

The narrative prompts 204 may occur, for example, at or towards the end of a narrative segment 202 and may include a plurality of icons or other content consumer selectable elements including various visual effects (e.g., highlighting) that each represent a different narrative path that the media content consumer 130 can select to proceed with the narrative presentation 164.

As described herein, specific implementations may advantageously include in the narrative prompts 204 an image of an actor or character that appears in currently presented narrative segment. As described elsewhere herein, specific implementations may advantageously present the narrative prompts 204 while a current narrative segment is still being presented or played (i.e., during presentation of a sequence of a plurality of images of the current narrative segment), for example as a separate layer (overlay, underlay) for a layer in which the current narrative segment is presented. The specific implementations may advantageously format the narrative prompts 204 to mimic a look and feel of the current narrative segment, for instance using intrinsic and extrinsic parameters of the camera(s) or camera(s) and lens combination with which the narrative segment was filmed or recorded. As described herein, specific implementations may advantageously apply various effects in two- or three-dimensions to move the narrative prompts 204 either with, or with respect to, images in the current narrative segment. Intrinsic characteristics of a camera (e.g., camera and lens combination) can include, for example one or more of: a focal length, principal point, focal range, aperture, lens ratio or f-number, skew, depth of field, lens distortion, sensor matrix dimensions, sensor cell size, sensor aspect ratio, scaling, and, or distortion parameters. Extrinsic characteristics of a camera (e.g., camera and lens combination) can include, for example one or more of: a location or position of a camera or camera lens combination in three-dimensional space, an orientation of a camera or camera lens combination in three-dimensional space, or a viewpoint of a camera or camera lens combination in three-dimensional space. A combination of a position and an orientation is referred to herein and in the claims as a pose.

Each of the narrative paths may result in a different narrative segment 202 subsequently being presented to the media content consumer 130. The presentation of the available narrative paths and the narrative prompt may be caused by an application program being executed by one or more of the media content consumer processor-based device 132 and/or networked servers, such as Webserver 160.

While not expressly illustrated, at least one component (e.g., processor) of the system receives a signal that represents the selection of the desired narrative path by the media content consumer 130. For example, the signal can be received at a media content consumer device, which is local to and operated by the media content consumer 130. For example, where the narrative segments are stored locally at the media content consumer device, the received signal can be processed at the media content consumer device. Also for example, the signal can be received at a server computer system from the media content consumer device, the server computer system which is remote from the media content consumer and the media content consumer device. For example, where the narrative segments are stored remotely from the media content consumer device, the received signal can be processed remotely, for instance at the server computer system.

In response to a selection, at least one component (e.g., processor) of the system causes a presentation of a corresponding narrative segment 202 to the media content consumer 130. The corresponding narrative segment 202 can be a specific narrative segment identified by the received narrative path selection.

Such a presentation may be made, for example, via any one or more types of output devices, such as a video/computer, screen or monitor, speakers or other sound emitting devices, displays on watches or other types of wearable computing device, and/or electronic notebooks, tablets, or other e-readers. For example, a processor of a media content consumer device may cause the determined narrative segment 202 to be retrieved from on-board memory, or alternatively may generate a request for the narrative segment to be streamed from a remote memory or may otherwise retrieve from a remote memory or storage, and placed in a queue of a video memory. Alternatively or additionally, a processor of a server located remotely from the media content consumer device may cause a streaming or pushing of the determined narrative segment 202 to the media content consumer device, for instance for temporary placement in a queue of a video memory of the media content consumer device.

The method 800 ends at 818 until invoked again. The method 800 may be invoked, for example, each time a narrative prompt 204 appears during a narrative presentation 164.

The processor-based system may employ various file types, for instance an COLLADA file. COLLADA is a standard file format for 3D objects and animations The processor-based system may initialize various parameters (e.g., animation start time, animation end time, camera depth of field, intrinsic characteristics or parameter, extrinsic characteristic or parameters). The processor-based system may cause one or more virtual three-dimensional (3D) cameras to be set up on respective ones of one or more layers, denominated as 3D virtual camera layers, the respective 3D virtual camera layers being separate from a layer on which narrative segments are presented or are to be presented. For instance, the processor-based system may can create one or more respective drawing or rendering layers. One or more narrative segments may have been filmed or captured with a physical camera, for instance with a conventional film camera (e.g., Red Epic Dragon digital camera, Arri Alexa digital camera), or with a 3D camera setup. Additionally or alternatively, one or more narrative segments may be may be computer generated animation (CGI) or other animation. One or more narrative segments may include special effects interspersed or overlaid with live action. The processor-based system may cause the 3D virtual camera layers to overlay a layer in which the narrative segments are presented (e.g., overlay video player), with the 3D virtual camera layer set to be invisible or hidden from view. For example, the processor-based system may set a parameter or flag or property of the 3D virtual camera layer or a narrative presentation layer to indicate which overlay the other with respect to a viewer or media content consumer point of view.

The processor-based system may request narrative segment information. For example, the processor-based system may request information associated with a first or a current narrative segment (e.g., video node). Such may be stored as data in a data store logically associated with the respective narrative segment or may comprise metadata of the respective narrative segment.

The processor-based system may determine whether the respective narrative segment has one or more decision points (e.g., choice moments). For example, the processor-based system may query information or metadata associated with a current narrative segment to determine whether there is one or more points during the current narrative segment at which a decision can be made as to which of two or more path directions are to be taken through the narrative presentation. For example, the processor-based system may request information associated with the current narrative segment (e.g., video node). Such may be stored as data in a data store logically associated (e.g., pointer) with the respective narrative segment or may comprise metadata of the respective narrative segment.

The processor-based system may determine whether the narrative presentation or the narrative segment employs a custom three-dimensional environment. For example, the processor-based system can query a data structure logically associated with the narrative presentation or the narrative segment or query metadata associated with the narrative presentation or the narrative segment.

In response to a determination that the narrative presentation or the narrative segment employs a custom three-dimensional environment, the processor-based system may cause a specification of the custom 3D environment to be downloaded.

The processor-based system may map one or more 3D virtual cameras to a three-dimensional environment. For example, the processor-based system can map or otherwise initialize one or more 3D virtual cameras using a set of intrinsic and, or, extrinsic characteristics or parameters. Intrinsic and, or, extrinsic characteristics or parameters can, for example, include one or more of: animation start time and stop time for an entire animation. Intrinsic and, or, extrinsic characteristics or parameters for the camera can, for example, include one or more of: a position and an orientation (i.e. pose) of a camera at each of a number of intervals; a depth of field or changes in a depth of field of a camera at each of a number of intervals; an aperture of or changes in an aperture of a camera at each of a number of intervals; a focal distance or focal length of or changes in a focal distance or focal length of a camera at each of a number of intervals. Notably, intervals can change in length, for instance depending on how camera movement is animated. Intrinsic and, or, extrinsic characteristics or parameters for objects (e.g., virtual objects), can, for example, includes: a position and an orientation (i.e. pose) of an object at each of a number of intervals. Virtual objects can, for example, take the form of narrative prompts, in in particular narrative prompts that take the form of, or otherwise include, a frame or image from a respective narrative segment what will be presented in response to a section of the respective narrative prompt. These parameters can all be extracted from a COLLADA file where such is used.

The 3D environment may have animations to the camera and narrative prompts embedded in the 3D environment. As an example of the mapping, a processor of a media content consumer device and, or a server computer system may cause the 3D virtual camera to track with a tracking of the physical camera across a scene. For instance, if between a first time 0.2 seconds into the narrative segment and a second time 1.8 seconds into the narrative segment we're supposed to move the camera 30 units to the right, then upon reaching the appropriate time (e.g., 0.2 seconds into the narrative segment) the system causes the 3D virtual to move accordingly. Such can advantageously be used to sweep or otherwise move the narrative prompts into, and across, a scene of the current narrative segment while the current narrative segment continues to be presented or play (i.e., continue to successively present successive frames or images of the narrative segment).

If it is determined that the current narrative segment has one or more decision points, then the processor-based system may determine or parse out a time to present the narrative prompts (e.g., choice moment overlays). For example, the processor-based system may retrieve a set of defined time or temporal coordinates for the specific current narrative segment, or a set of defined time or temporal coordinates that are consistent for each of the narrative segments the comprise a narrative presentation.

The processor-based system may create narrative prompt overlay views with links to corresponding narrative segments, for example narrative segments corresponding to the available path directions that can be chosen from the current narrative segment. The narrative prompt overlay are initially set to be invisible or otherwise hidden from view via the display or screen on which the narrative presentation will be, or is being, presented. For example, a processor of a media content consumer device and, or a server computer system can generate a new layer, in addition to a layer in which a current narrative segment is presented. The new layer includes a user selectable element or narrative prompt or visual distinct indication, and preferably includes a first frame or image of the narrative segment to which the respective user interface element or narrative prompt is associated (e.g., the narrative segment that will be presented subsequent to the current narrative segment when the respective narrative prompt is selected). The processor of a media content consumer device and, or a server computer system can employ a defined framework or narrative prompt structure that is either specific to the narrative segment, or that is consistent across narrative segments that comprise the narrative presentation. The defined framework or structure may be pre-populated with the first image or frame of the corresponding narrative segment. Alternatively, the processor of a media content consumer device and, or a server computer system can retrieve the first image or frame of the corresponding narrative segment and incorporate such in the defined framework or structure when creating the new layer. The processor of a media content consumer device and, or a server computer system can set a parameter or flag or property of the new layer to render the new layer initially invisible.

The processor-based system may then cause a presentation or playing of the current narrative segment (e.g., video segment) on a corresponding layer (e.g., narrative presentation layer) along with the user interface element(s) on a corresponding layer (e.g., user interface layer).

As previously described, the system may advantageously employ camera characteristics or parameters of a camera used to film or capture an underlying scene in order to generate or modify one or more user interface elements (e.g., narrative prompts) and, or a presentation of one or more user interface elements. For example, the system may advantageously employ camera characteristics or parameters of a camera used to film or capture an underlying scene in order to generate or modify one or more user interface elements (e.g., narrative prompts) and, or a presentation of one or more user interface elements to match a look and feel of the underlying scene. For instance, the system may match a focal length, focal range, lens ratio or f-number, focus, and, or depth-of-field. Also for instance, the system can generate or modify one or more user interface elements (e.g., narrative prompts) and, or a presentation of one or more user interface elements based on one or more camera motions, whether physical motions of the camera that occurred while filming or capturing the scene or motions (e.g., panning) added after the filming or capturing, for instance via a virtual camera applied via a virtual camera software component. Such can, for instance, be used to match a physical or virtual camera motion. Additionally or alternatively, such can, for instance, be used to match a motion of an object in a scene in the underlying narrative. For instance, a set of user interface elements can be rendered to appear to move along with an object in the scene. For instance, the set of user interface elements can be rendered to visually appear as if they were on a face of a door, and move with the face of the door as the door pivots open or closed. To achieve such, the system can render the user interface elements, for example, on their own layer or layers, which can be a separate layer from a layer on which the underlying narrative segment is rendered.

In some implementations, the system may receive one or more camera characteristics or parameters (e.g., intrinsic camera characteristics or parameters, extrinsic camera characteristics or parameters) via user input, entered for example by an operator. In such implementations, the system may, for example, present a user interface with various fields to enter or select one or more camera characteristic. Additionally or alternatively, the user interface may present a set (e.g. two or more) of camera identifiers (e.g., make/model/year, with or without various lens combinations), for instance as a scrollable list or pull-down menu, or with a set of radio buttons, for the operator to choose from. Each of the cameras or camera and lens combinations in the set can be mapped to a corresponding defined set of camera characteristics or parameters in a data structure stored one or more processor-readable media (e.g., memory). In some implementations, the system autonomously determines one or more camera characteristics or parameters by analyzing one or more frames of the narrative segment. While generally described in terms of a second video overlay, the user interface elements or visual emphasis (e.g., highlighting) may be applied using other techniques. For example, information for rendering or displaying the user interface elements or visual emphasis may be provided as any one or more of a monochrome video; a time-synchronized byte stream, for instance that operates similar to a monochrome video but advantageously using less data; or a mathematical representation of the overlays over time which can be rendered dynamically by an application executing on a client device used by an end user or view or content consumer.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet, including but not limited to U.S. provisional patent application Ser. No. 62/740,161; U.S. Pat. No. 6,554,040; U.S. provisional patent application Ser. No. 61/782,261; U.S. provisional patent application Ser. No. 62/031,605; and U.S. nonprovisional patent application Ser. No. 14/209,582, with the present disclosure are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1.-26. (canceled)

27. A processor-based system that is operable to present a number narratives, each of the narratives comprising a respective plurality of narrative segments, each of the of narrative segments comprising a respective plurality of successive images, the system comprising:
at least one processor comprising a number of circuits;
at least one nontransitory processor-readable medium communicatively coupled to the at least processor and which stores at least one of processor-executable instructions or data which, when executed by the at least one processor, cause the at least one processor to:
position a virtual camera at a center of a virtual shell, the virtual shell having an internal surface, the internal surface of the virtual shell being concave; and; and
apply a 360 degree video of a first set of primary content as a first video texture onto at least a portion of the internal surface of the virtual shell.

28. The system of claim 27 wherein the at least one of processor-executable instructions or data, when executed by the at least one processor, further cause the at least one processor to:
set a normal vector for the first video texture to a value that causes the first video texture to appear on the internal surface of the virtual shell.

29. The system of claim 28 wherein to set a normal vector for the first video texture to a value that causes the first video texture to appear on the internal surface of the virtual shell the at least one of processor-executable instructions or data, when executed by the at least one processor, cause the at least one processor to: change a default value of the normal vector for the video texture.

30. The system of claim 27 wherein the virtual shell is a virtual spherical shell and to apply a 360 degree video of a first set of primary content as a first video texture onto at least a portion of the internal surface of the virtual shell comprises applying the first video texture onto an entirety of the internal surface of the virtual spherical shell.

31. The system of claim 27 wherein the virtual shell is a virtual closed spherical shell and applying a 360 degree video of a first set of primary content as a first video texture onto at least a portion of the internal surface of the virtual shell the at least one of processor-executable instructions or data, when executed by the at least one processor, cause the at least one processor to: apply the first video texture onto an entirety of the internal surface of the virtual closed spherical shell.

32. The system of claim 27 where to apply a 360 degree video of a first set of primary content as a first video texture onto at least a portion of the internal surface of the virtual shell the at least one of processor-executable instructions or data, when executed by the at least one processor, cause the at least one processor to: apply a monoscopic 360 degree video of the first set of primary content as the first video texture onto at least the portion of the internal surface of the virtual shell.

33. The system of claim 27 wherein the at least one of processor-executable instructions or data, when executed by the at least one processor, further cause the at least one processor to:
apply a video of a set of user interface elements that includes visual cues that denote interactive areas as a second video texture onto at least a portion of the internal surface of the virtual shell, spatially and temporally mapped to respective elements of the primary content of the 360 degree video of the first set of primary content.

34. The system of claim 33 wherein at least one of the visual cues is a first color and to apply a video of a set of user interface elements that includes visual cues that denote interactive areas as a second video texture onto at least a portion of the internal surface of the virtual shell the at least one of processor-executable instructions or data, when executed by the at least one processor, cause the at least one processor to: apply the video of the set of user interface elements that includes the first color as a first one of the visual cues and that denotes a first interactive area as the second video texture onto at least the portion of the internal surface of the virtual shell.

35. The system of claim 33 wherein at least one of the visual cues is a first image and to apply a video of a set of user interface elements that includes visual cues that denote interactive areas as a second video texture onto at least a portion of the internal surface of the virtual shell the at least one of processor-executable instructions or data, when executed by the at least one processor, cause the at least one processor to: apply the video of the set of user interface elements that includes the first image as a first one of the visual cues and that denotes a first interactive area as the second video texture onto at least the portion of the internal surface of the virtual shell.

36. The system of claim 33 wherein at least one of the visual cues is a first video cue comprising a sequence of images and to apply a video of a set of user interface elements that includes visual cues that denote interactive areas as a second video texture onto at least a portion of the internal surface of the virtual shell the at least one of processor-executable instructions or data, when executed by the at least one processor, cause the at least one processor to: apply the video of the set of user interface elements that includes the first video cue as a first one of the visual cues and that denotes a first interactive area as the second video texture onto at least the portion of the internal surface of the virtual shell.

37. The system of claim 33 wherein at least one of the visual cues is a first outline of a first character that appears in the primary content and to apply a video of a set of user interface elements that includes visual cues that denote interactive areas as a second video texture onto at least a portion of the internal surface of the virtual shell the at least one of processor-executable instructions or data, when executed by the at least one processor, cause the at least one processor to: apply the video of the set of user interface elements that includes the first outline of the first character as a first one of the visual cues and that denotes a first interactive area as the second video texture onto at least the portion of the internal surface of the virtual shell.

38. The system of claim 33 wherein at least one of the visual cues comprises a first outline of a first character that appears in the primary content with an interior of the first outline filled with a first color and to apply a video of a set of user interface elements that includes visual cues that denote interactive areas as a second video texture onto at least a portion of the internal surface of the virtual shell the at least one of processor-executable instructions or data, when executed by the at least one processor, cause the at least one processor to: apply the video of the set of user interface elements that includes the first outline of the first character filled with the first color as a first one of the visual cues and that denotes a first interactive area as the second video texture onto at least the portion of the internal surface of the virtual shell.

39. The system of claim 33 wherein a first one of the visual cues comprises a first outline of a first character that appears in the primary content with an interior of the first outline filled with a first color, a second one of the visual cues is a second outline of a second character that appears in the primary content with an interior of the second outline filled with a second color, the second character different from the first character, and to apply a video of a set of user interface elements that includes visual cues that denote interactive areas as a second video texture onto at least a portion of the internal surface of the virtual shell the at least one of processor-executable instructions or data, when executed by the at least one processor, cause the at least one processor to: apply the video of the set of user interface elements that includes the first outline of the first character filled with the first color and the second outline of the second character filled with the second color as the first one and the second one of the visual cues and that respectively denote a first interactive area and a second interactive area as the second video texture onto at least the portion of the internal surface of the virtual shell.

40. The system of claim 33 wherein at least one of the visual cues comprises a first outline of a first character that appears in the primary content with an interior of the first outline filled with a first color, at least one of the visual cues is a second outline of a second character that appears in the primary content with an interior of the second outline filled with a second color, the second character different from the first character, and to apply a video of a set of user interface elements that includes visual cues that denote interactive areas as a second video texture onto at least a portion of the internal surface of the virtual shell the at least one of processor-executable instructions or data, when executed by the at least one processor, cause the at least one processor to: apply the video of the set of user interface elements that includes the first outline of the first character filled with the first color and the second outline of the second character filled with the second color as a first one and a second one of the visual cues and that respectively denote a first interactive area and a second interactive area as the second video texture onto at least the portion of the internal surface of the virtual shell.

41. The system of claim 33 wherein a number of the visual cues comprises a respective outline of each of a number one or more characters that appear in the primary content, and to apply a video of a set of user interface elements that includes visual cues that denote interactive areas as a second video texture onto at least a portion of the internal surface of the virtual shell the at least one of processor-executable instructions or data, when executed by the at least one processor, cause the at least one processor to: apply the video of the set of user interface elements that includes the outlines of the characters as respective ones of the visual cues and that respectively denote respective ones of a number of interactive areas as the second video texture onto at least the portion of the internal surface of the virtual shell.

42. The system of claim 33 wherein a number of the visual cues comprises a respective outline of each of a number one or more characters that appear in the primary content, and to apply a video of a set of user interface elements that includes visual cues that denote interactive areas as a second video texture onto at least a portion of the internal surface of the virtual shell the at least one of processor-executable instructions or data, when executed by the at least one processor, cause the at least one processor to: apply the video of the set of user interface elements that includes the outlines of the characters filled with a respective unique color from a set of colors as respective ones of the visual cues and that respectively denote respective ones of a number of interactive areas as the second video texture onto at least the portion of the internal surface of the virtual shell.

43. The processor-based system of claim 31 wherein, when executed by at least one processor, the at least one of processor-executable instructions or data cause the at least one processor further to:

44. The system of claim 42 wherein to apply a video of a set of user interface elements that includes visual cues that denote interactive areas as a second video texture onto at least a portion of the internal surface of the virtual shell the at least one of processor-executable instructions or data, when executed by the at least one processor, cause the at least one processor to: apply the video of the set of user interface elements that includes a visual treatment that at least partially obscures any of the primary content of the first set of primary content that appears in any area outside of any of the respective outlines of each of the number of characters that appear in the primary content.

45. The system of claim 43 wherein to apply the video of the set of user interface elements that includes a visual treatment that at least partially obscures any of the primary content of the first set of primary content that appears in any area outside of any of the respective outlines of each of the number of characters that appear in the primary content the at least one of processor-executable instructions or data, when executed by the at least one processor, cause the at least one processor to: apply the video of the set of user interface elements that includes a translucent visual treatment over any area outside of any of the respective outlines of each of the number of characters that appear in the primary content.

46. The system of claim 43 wherein to apply the video of the set of user interface elements that includes a visual treatment that at least partially obscures any of the primary content of the first set of primary content that appears in any area outside of any of the respective outlines of each of the number of characters that appear in the primary content the at least one of processor-executable instructions or data, when executed by the at least one processor, cause the at least one processor to: apply the video of the set of user interface elements that includes an opaque visual treatment over any area outside of any of the respective outlines of each of the number of characters that appear in the primary content.

47. The system of claim 33 wherein the at least one of processor-executable instructions or data, when executed by the at least one processor, further cause the at least one processor to:
in response to a selection of one of the user interface elements of the set of user interface elements, apply a 360 degree video of a second set of primary content as a first video texture onto at least a portion of the internal surface of the virtual shell.

48. The system of claim 47 the at least one of processor-executable instructions or data, when executed by the at least one processor, further cause the at least one processor to:
apply the video of a set of user interface elements that includes visual cues that denote interactive areas as a third video texture onto at least a portion of the internal surface of the virtual shell, spatially and temporally mapped to respective elements of the primary content of the 360 degree video of the second set of primary content.

49. The system of claim 27 wherein the at least one of processor-executable instructions or data, when executed by the at least one processor, further cause the at least one processor to:
in response to an input received via one of the user interface elements adjust a pose of the virtual camera.

50. The system of claim 27 wherein the at least one of processor-executable instructions or data, when executed by the at least one processor, further cause the at least one processor to:
apply a set of user interface elements that includes visual cues that denote interactive areas onto at least a portion of the internal surface of the virtual shell, spatially and temporally mapped to respective elements of the primary content of the 360 degree video of the first set of primary content.

51. The system of claim 50 wherein to apply the set of user interface elements the at least one processor applies a monochrome video; a time-synchronized byte stream;
or a mathematical representation of one or more overlays over time that is dynamically renderable by an application executing on a client device.
